(19) United States
(12) Patent Application Publication
(10) Pub. No.: US 2016/0215690 A1
(43) Pub. Date: Jul. 28, 2016

(54) DUAL CHEMICAL INDUCTION CLEANING METHOD AND APPARATUS FOR CHEMICAL DELIVERY

(71) Applicants: Bernie C. Thompson, Tijeras, NM (US); Neal R. Pederson, Los Alamos, NM (US)

(72) Inventors: Bernie C. Thompson, Tijeras, NM (US); Neal R. Pederson, Los Alamos, NM (US)

(21) Appl. No.: 14/584,684

(22) Filed: Dec. 29, 2014

Related U.S. Application Data
(63) Continuation-in-part of application No. 62/061,326, filed on Oct. 8, 2014.

(51) Int. Cl. F02B 77/04

(52) U.S. Cl. CPC F02B 77/04

(57) ABSTRACT

This invention relates to the field of induction cleaning, more particularly to chemically cleaning the induction system of the internal combustion engine. The carbon that accumulates within the induction tract of the internal combustion engine is very difficult to remove. Chemically these carbon deposits are very close to that of asphalt or bitumen. It has been found that if the induction cleaning chemicals are delivered in timed layered intervals the removal of such induction carbon can be accomplished. The Dual Solenoid Induction Cleaner uses electronically controlled solenoids to deliver at least two different chemistries in alternating layers to the engine's induction system. These electric solenoids are connected to a single induction cleaner nozzle. The induction cleaner nozzle is slipped through the vacuum port opening into the inside of the induction system where it will spray an aerosol of the chemistry directly into the moving air column entering the engine.

### CLAIM OF PRIORITY

This application is a continuation of and claims the priority of provisional application Ser. No. 62/061,326, filed Oct. 8, 2014.

### FIELD OF INVENTION

This invention relates to the field of induction cleaning, more particularly to chemically cleaning the induction system of the internal combustion engine. This method uses chemicals, typically different, delivered in stages in order to remove buildup of carbon accumulation from the induction system or intake track which can include the throttle body, throttle plate, intake plenum, intake manifold, intake charge valve, intake runners, intake opening or port, and intake valve. It has been found that if the induction cleaning chemicals are delivered in timed intervals (sometimes referred to as layers or layering) the removal of such induction carbon can be accomplished. A preferred embodiment uses electronically controlled solenoids to deliver at least two different chemistries in alternating layers to the engine's induction system.

### BACKGROUND OF THE INVENTION

Even though the carbon compounds that accumulate in the engine are unwanted, carbon is very much a part of the internal combustion engine. This is due to the fact that lubricants and fuels used in the engine are carbon based compounds. The lubricant and fuel carbon bonds are formed with hydrogen and produce hydrocarbon chains. These hydrocarbon chains are refined from crude oil and contain various molecular weights. When these hydrocarbon chains are formed to produce lubricating oil they contain heavier, thicker petroleum based stock that have between 18 and 34 carbon atoms per molecule. Lubricating oil creates a separating film between the engine's moving parts that is used to minimize direct contact between the moving parts which decreases heat caused by friction and reduces wear, thus protecting the engine. When these hydrocarbon chains are made for fuel such as gasoline, they contain lighter petroleum based stock that have between 4 and 12 carbon atoms per molecule. Overall, a typical gasoline is predominantly a mixture of paraffins (alkanes), cycloalkanes (naphthenes), and olefins (alkenes). Fuel is blended to produce a rapid high energy release combustion event that propagates through the air in the combustion chamber at subsonic speeds and is driven by the transfer of heat. As the internal combustion engine is operated the fuel's energy is released in the combustion chamber. This occurs by a chemical change in the hydrocarbon chains. The heat from the ignition spark (gasoline) or from the compression (diesel) breaks the hydrocarbon chains so the bonds between the carbon and hydrogen are separated. This allows the carbon to bond with dioxygen (O2), and the hydrogen to bond with oxygen (O); thus changing the hydrocarbon chains to carbon dioxide (CO2), and water (H2O). However, if there is a lack of oxygen during the burning of the fuel then pyrolysis occurs. Pyrolysis is a type of thermal decomposition that occurs in organic materials exposed to high temperatures. Pyrolysis of organic substances such as fuel produces gas and liquid products that leave a solid, carbon rich residue. Heavy pyrolysis leaves mostly carbon as a residue and is referred to as carbonization.

As this carbon buildup creates tailpipe emission problems, drivability problems, and poor fuel economy, it is desirable to remove this buildup from the internal combustion engine. This carbon can be removed by engine disassembly and manual cleaning, however this is very time consuming and expensive. An easier, less expensive alternative is to remove this carbon buildup using chemicals to clean the engine. Over the years there have been numerous attempts involving the use of cleaning apparatus and chemicals to solve the problem of carbon buildup removal.

In U.S. Pat. No. 4,671,230 Turnipseed discloses a device that holds or contains a mixture of carbon cleaning solution and gasoline. The vehicle's fuel supply system is disabled from the engine and the invention is connected to the fuel delivery for the engine. The invention then supplies the engine with the pressurized cleaning solution as the engine is run. This cleaning solution is then delivered through the engine injectors. The problem with this method is that the cleaning solution is only applied to the intake valve and the immediate intake port area around the intake valve. The rest of the induction system remains uncleaned. Additionally, if the engine is that of a direct injection design, no intake cleaning will take place at all.

In U.S. Pat. No. 4,989,561 Hein discloses a device that connects to the throttle body of the engine. The device or metering block has an adjustment to increase or decrease the air flow into the engine. This air flow adjustment will set the air rate into the engine, thus bypassing the throttle plate control. The metering block also holds an electronic automotive style fuel injector that will deliver the cleaning chemical. The vehicle fuel system is disabled by unplugging the fuel injectors or fuel pump. If the vehicle is equipped with a Mass Air Flow (MAF) sensor an additional tube must be connected from the metering block to the MAF sensor. The throttle is then depressed and the engine is started and run on the cleaner solution that is pressurized and delivered to the engine. Once the cleaning solvent has been delivered and all of the chemical has been used, a second chemical is then added and the engine is run until all of this chemical has been used.

The problems with this method are threefold. The first problem is the complication and time to install the invention. The second problem is the engine Revolutions Per Minute (RPM) cannot be varied above the adjustment point of the metering block adjustment. The ability to change the RPM, which in turn changes the energy of the air flowing into the engine, is important. Since the energy of the air flow is carrying the chemical it will be necessary to raise the RPM and have a rapid throttle opening or snap throttle of the engine. This increased air flow will help prevent the chemical from puddling within the intake manifold as well as carry additional chemical to the carbon sites. The third problem occurs if the engine is equipped with Drive-by-wire. Drive-by-wire systems were first installed on vehicles as early as 1989 and by 2003 is standard equipment for most U.S. based vehicles. This system is a safety critical system where the Engine Control Unit (ECU) controls and monitors the throttle plate position. If the throttle plate position does not match the air flow rate commanded into the engine by the ECU the system is put into a default position. There are many different defaults that can be command by the ECU in order to maintain the air rate in to the engine. One such default could cause the engine to shut down by cutting the fuel, spark and air to the engine. Another default is accomplished whereby the throttle plate position is no longer controlled by the ECU but will allow the throttle plate position to be slightly opened by the default spring which will only allow the engine to run at about 1800 RPM. Additionally the fuel and spark can be turned on and off in order to control the air rate and RPM of the engine, which will cause severe damage to the catalytic converter. In yet another default the Drive-by-wire system will force the throttle shut when the expected air rate cannot be obtained.

In U.S. Pat. No. 6,557,517 B2 Augustus discloses a device that applies cleaning chemical into the engine through the spark plug hole. A single chemical cleaner is installed in the invention's multiple reservoirs in the main cylindrical body. The spark plugs are removed from the engine and an adapter is installed into each of the spark plug holes that are connected with hoses to the main cylindrical body. The main cylindrical body also contains a metering valve system that allows the chemical to be delivered directly into the cylinder without the engine hydrolocking or liquid locking. The cleaning chemical is put into the cylinder in order to clean the piston compression rings. In order to clean the piston rings the starter motor is bumped. Bumping means the starter is engaged for a very short time to move the piston up or down several inches. This piston movement when repeated multiple times with chemical cleaner applied to the piston ring will clean the carbon from the piston and piston ring.

The problem with this method is twofold. The first problem is the amount of time and knowledge required to install such a complicated device. The second problem is the only carbon removal that is accomplished is in the combustion chamber. The induction system or intake tract which can include; the throttle body, throttle plate, intake plenum, intake manifold, intake charge valve, intake runners, intake port, and intake valve are not cleaned at all by the invention.

In U.S. Pat. No. 6,530,392 B2 Blatter discloses a device that applies cleaning chemical into the engine through the vacuum port. The base of the device holds a can of chemical cleaner and has a means to adjust the flow rate of the cleaner that can be observed through a sight glass. The base is connected to the nozzle with a tube. The nozzle has a hole drilled at a 90 degree angle that will bleed air from the atmosphere into the discharge. The nozzle is connected to the engine vacuum hose on the engine's intake system. The engine is then started and run where the low pressure created by the running engine pulls the cleaner into the intake tract. The cleaner can be adjusted by turning the adjustment screw while watching the flow through the sight glass. The entire can of chemical is delivered in one continuous application to try to clean the engine. As the cleaner is pulled through the discharge nozzle air from the atmosphere moves through the air bleed, located in the discharge nozzle, where it is mixed with the chemical cleaner. This air bleed breaks up the liquid cleaner into droplets as it is delivered into the intake tract.

The problem with this design and its method of use is the droplet size is not consistent as is illustrated in Applicant's FIG. 10. As the engine is running the droplet sizes are both small and large without being held constant; with the larger sizes moving slower than the smaller droplet sizes in the air flow, they tend to congeal together making much larger droplets. As the liquid is broken up into droplets by the air bleed, the air to cleaner ratio is constantly changing. This allows the creation of droplets that are too large to be transported by the air flow making it difficult for the chemical to reach the carbon sites on the intake runner top and sides as well as the intake port top and sides. Thus, only some carbon is cleaned and some remains. Additionally there is very little vacuum under cranking and snap throttle conditions, so no chemicals can be pulled from the reservoir and be delivered to the induction system under these conditions.

As can be seen the prior art has many limitations. These limitations pose significant problems when cleaning the induction system. What is needed is the means to quickly and easily remove the carbon from the internal combustion engine. The present invention accomplishes this.

### PROJECTS AND OBJECTS

The above described systems all have problems removing the carbon from the internal combustion engine's induction system in real world situations. For any chemical to be affective it must first be delivered to the carbon sites. To accomplish this air flowing into the engine is used. The energy of the moving air column will carry the chemical into the engine. The question is how effectively is the chemical being carried to the carbon sites?

In modern engine designs the intake tract often has a scroll style intake (e.g. U.S. Pat. No. 7,533,644, U.S. Pat. No. 4,741,294 A). The air entering through the throttle body may be at a lower point than the intake valve. Additionally the intake tract may scroll upward and then back down to the intake valve port area. The intake may also have a charge valve which isolates two different intake runner lengths, these different length runners help with cylinder charge or fill. When induction cleaning chemical droplets are in the air column and are moving around these intake bends the droplets tend to fall out of the air column to the intake system's floor. When this occurs the intake tract floor can be cleaned, however the intake tract top and sides are left with carbon deposits. With this intake tract design, it is necessary to have small droplets or a true aerosol delivered to the intake tract. Further, this aerosol or small droplets needs to be delivered directly into the moving air column after the throttle plate. If the aerosol hits an obstruction such as the throttle plate or throttle body, or if the delivery system makes varying droplet sizes (e.g., Blatter), then the droplets will congeal into larger heavier droplets. These heavier droplets are unable to be supported by the energy of the moving air column and tend to fall out to the induction system's floor.

Furthermore, the carbon compounds within the internal combustion engine can vary in chemical composition and thickness making it very difficult to remove. The carbon from a running engine can be produced from the fuel or from the motor oil. Since both the fuel and motor oil are hydrocarbon based they can produce carbon compounds that can accumulate. Additionally if the engine is equipped with an Exhaust Gas Recirculation (EGR) system the burned hydrocarbons contained in exhaust gases can also accumulate in the induction system. The different types of carbon compounds and the amount of carbon accumulation within an engine will vary depending on several different variables such as the type of hydrocarbons the fuel is made of, the detergents added to the fuel base, the type of hydrocarbons the motor oil is made of, the operating temperature of the engine, the pressure the carbon is produced under, the load on the engine, the engine drive time, the engine drive cycle, and the engine design. Each of these variables will affect the type of carbon that will be produced and the carbon accumulation that will accrue within the engine.

It is important to understand that the carbon produced within an engine is not all the same. The carbon in the combustion chamber is produced under high heat and high pressure, creating a carbon that is denser and has low porosity. Additionally the carbon thickness is usually low. These combustion chamber deposits will cause high tailpipe emissions and pre-ignition problems which can cause serious engine damage. The carbon that is produced within the induction system is created under very different conditions than the combustion chamber deposits.

The carbon in the intake is produced under low heat and low pressure, creating a carbon that has high porosity. Additionally the carbon thickness can be quite high. The intake carbon accumulation can be produced in different areas such as the throttle body, intake plenum, intake runner, intake port, and the intake valve. These carbon deposits can disrupt the air flow into the cylinder causing performance and drivability issues. The more uneven the carbon accumulations are, the greater the air disruptions will be. These uneven intake carbon accumulations decrease power, torque, and fuel economy. With heavy intake carbon accumulations misfire conditions can also occur. This can be caused by major air disruptions or carbon creating valve sealing issues. Additionally the intake carbon deposits can create cold drivability issues; the intake carbon being very porous allows the fuel to be absorbed into the carbon creating a cold lean run condition.

The carbon that has accumulated within the induction system of the engine is very difficult to remove. Chemically these carbon deposits are very close to that of asphalt or bitumen. In order to break these carbon bonds down and remove them from the induction system it will require not only the use of chemicals capable of removing such carbon buildup, but the use of the layering technique of the present invention. This chemical layering technique can remove different carbon compound types and carbon thicknesses from the internal combustion engine.

What is needed is a method and apparatus that can quickly and accurately clean the induction system of the internal combustion engine regardless of the engine design or the amount of carbon buildup within the engine. The present invention accomplishes these goals.

### SUMMARY OF THE INVENTION

The present invention relates to both apparatus and methods of applying chemicals to the induction system in stages in order for the removal of carbon buildup in the internal combustion engine. The method of removing carbon build up from the internal combustion engine includes, typically, the use of first and second different chemical compositions of matter (a “first chemistry” and “second chemistry”) each capable of removing at least some carbon in at least a portion of the engine, and apparatus for delivering the first and second chemistries to the induction system in a series of stages. The method includes:
running the engine;
applying the first chemistry to the induction system for a first period of time (a stage);
applying the second chemistry to the induction system for a second period of time (a second stage; the first and second stages constituting a cycle); and
repeating the cycle at least once.
   Typically, the method includes the step of including a time period (a pause stage) between the first and second stages wherein neither the first nor the second chemistry is being applied to the induction system to thereby permit at least one of the group including the first chemistry and the second chemistry to at least partially soak the carbon buildup in the induction system; the first, second and pause stages constituting the cycle. Alternately, the application of the second chemistry directly follows the application of the first chemistry. An additional alternative is to have the application of the second chemistry overlap the application of the first chemistry. While two different chemistries are typically used, the application of the chemistries in multiple stages can be affected with just one chemistry. And, in conjunction with this layering process, three or more different chemistries can be used.

A preferred apparatus includes a base assembly, microprocessor, control buttons, multiple reservoirs, air pressure regulator, pressure gauge, electronic controlled solenoids, delivery hoses, and an induction cleaner nozzle. The reservoirs are filled with two different chemical formulations or compositions of matter; a first chemistry and a second chemistry. An air pressure hose is connected to a pressure regulator that is connected to the base assembly to pressurize the chemistries contained in the reservoirs. These reservoirs are connected with delivery hoses to two electric solenoids. These two solenoids, or electric valves, are connected to a single induction cleaner nozzle. The induction cleaner nozzle is connected to an intake opening or port (e.g., vacuum port) on the engine intake tract. This nozzle is slipped through the port into the inside of the intake tract where it will sequentially spray small droplets (e.g., an aerosol) of each of the two chemistries. The solenoids are turned on and off in order to deliver the pressurized cleaning chemistries through the induction cleaner nozzle to the engine's induction system.

In such a preferred embodiment the solenoids are controlled by a microprocessor that has been programmed to deliver the chemistries to the induction system in 4 stages:

Stage 1: A first chemistry is applied for 30 seconds and is then shut off.

Stage 2: A period of 30 seconds where no chemistry is applied.

Stage 3: A second chemistry is applied for 30 seconds and is then shut off.

Stage 4: A period of 30 seconds where no chemistry is applied.

The foregoing timed interval sequences, or stages, are repeated for a period of, for instance, 25 minutes. The time period for each stage may be referred to as a run time. These run times can be varied depending on, for instance, the chemistries used. For example with different chemistries, the first stage could have a first run time of 5 seconds of chemistry being applied, followed by a 15 second pause time, and the second stage could have a second run time of 15 seconds of chemistry being applied, followed by a 30 second pause time. These stages would then be cycled, for instance, for 30 minutes.

In some circumstances the amount of chemistry being applied while the solenoid is on maybe increased by over 100% above the conventional amount of such chemistry that, based on the manufacturers recommendation, would normally be applied. A conventional amount of chemistry delivery is about 16 oz. in 20 minutes at a constant delivery rate, which equates to 0.8 oz. of chemical per minute. In a preferred embodiment the Dual Solenoid Induction Cleaner delivers 32 oz. of such chemistry in 12½ minutes, which equates to 2.56 oz. of chemical per minute. With this additional chemistry being delivered to the engine it becomes necessary to periodically stop the delivery. Without the above referenced 30 second pause the engine's catalytic converter, and/or the turbo charger, would overheat and become damaged. However, with this pause the catalytic converter, and/or the turbo charger, temperature can be maintained, thus protecting them from damage.

Additionally during the pause the chemistry has time to soak the carbon sites which helps with its removal. This pause stage could be carried out between just the first and second stage or just between the second and first stage. However, testing with the pause stage, and testing without the pause stage, clearly indicated that the chemistries worked better with a pause between each of the chemistry stages. Additionally through testing it has been determined that even if only one chemistry is used the pause stage allows the induction system to be cleaned far better than without the pause stage. This is due to the increased amount of time that the chemical is in contact with the carbon without saturating the carbon deposit. In some cases using some chemistries the carbon deposit will become gummy when saturated making the carbon deposit difficult to remove. With the traditional method of chemistry delivery the chemistry is continuously delivered into the induction system therefore keeping the carbon deposit saturated. However, with the chemistry delivery being paused the carbon does not become saturated. Thus, the chemistry can work far better at removing the carbon deposits from the induction system. Further, with the increased volume of chemistry being applied to the induction system there is actually enough to wash out or remove the carbon deposits. One of the real advantages of using two different chemistries is that the first chemistry will break down a small amount of the carbon surface and the second chemistry will remove or wash this small amount of carbon out of the engine. Thus, in the description of the apparatus in the preferred embodiment, the first chemistry may be referred to as cleaner and the second chemistry may be referred to as wash. By removing small amounts at a time the carbon can actually be removed on a repeatable base from the internal combustion engine. It should be appreciated that with different chemistries one may be formulated (or act more effectively) to remove, flush, or wash out the immediately preceding chemistry and carbon which has been previously loosened. It should also be appreciated that, after the application of the first chemistry for the first time, each following application of chemistry (whether the same chemistry or different chemistry) will have some washing effect.

If a lower weight of chemistry were delivered, such as the conventional amount normally used, the pause where no chemical is delivered between alternating applications of chemistry would not have to be carried out (however as described above the pause helps with the carbon deposit breakdown and removal). Since the chemical weight is much less the catalytic converter and/or the turbocharger temperature will not increase to a point of damage. However, with or without the pause, the alternating layering of the different chemistries will provide superior carbon removal.

It is important to understand that with conventional methods of chemistry delivery the engine is running while chemistry is delivered continuously (in bulk) to the engine. One example of this is if two different chemicals were going to be used and each chemical was 16 ounces, the entire 16 oz of the first chemical would be continuously delivered and then the entire 16 oz of second chemical would be continuously delivered. This conventional method of bulk delivery is not that of the repeated alternate stages (i.e., cycling) of the present invention and, thus, will exhibit problems with carbon removal.

### BRIEF DESCRIPTION OF THE DRAWINGS

FIG. 1 illustrates the block drawing of the induction cleaner of the present invention connected to an engine.

FIG. 2 illustrates the drawing of the induction cleaner from the front.

FIG. 3 illustrates the drawing of the induction cleaner from the back.

FIG. 4 illustrates the drawing of the induction cleaner from the right side.

FIG. 5 illustrates the drawing of the induction cleaner from the from left side.

FIG. 6 illustrates the drawing of the induction cleaner with a conventional oil burner nozzle.

FIG. 7 illustrates the drawing of the induction cleaner with the unique induction cleaner nozzle of the present invention.

FIG. 8 illustrates the drawing of the vacuum testing apparatus of the present invention.

FIG. 9 illustrates the drawing of the vehicle testing apparatus of the present invention.

FIG. 10 illustrates the drawing of the prior art air bleed induction cleaner nozzle working.

FIG. 11 illustrates the drawing of the conventional oil burner nozzle working.

FIG. 12 illustrates the drawing of the unique induction cleaner nozzle of the present invention working.

FIGS. 13A and B illustrate the cross sectional views of the induction cleaner nozzle of FIG. 12.

FIGS. 14A and B illustrate alternate slot designs for the nozzle of FIG. 12.

FIGS. 15A, B, and C illustrate the spray pattern from different slot designs.

FIGS. 16A-J illustrate, side and top views, the different line designs on the tapered screw cone of the nozzle of FIG. 12.

FIG. 17 illustrates the nozzle of FIG. 12 with a vertical arrangement of slots.

FIGS. 18A and B illustrate the nozzle of FIG. 12 with a series of slots in a plane perpendicular to the longitudinal axis of the nozzle.

FIG. 19 is a drawing of the induction cleaner's electronic control circuit.

FIGS. 20A and B show the Dual Solenoid Induction Cleaner program.

### DESCRIPTION OF THE PREFERRED EMBODIMENT

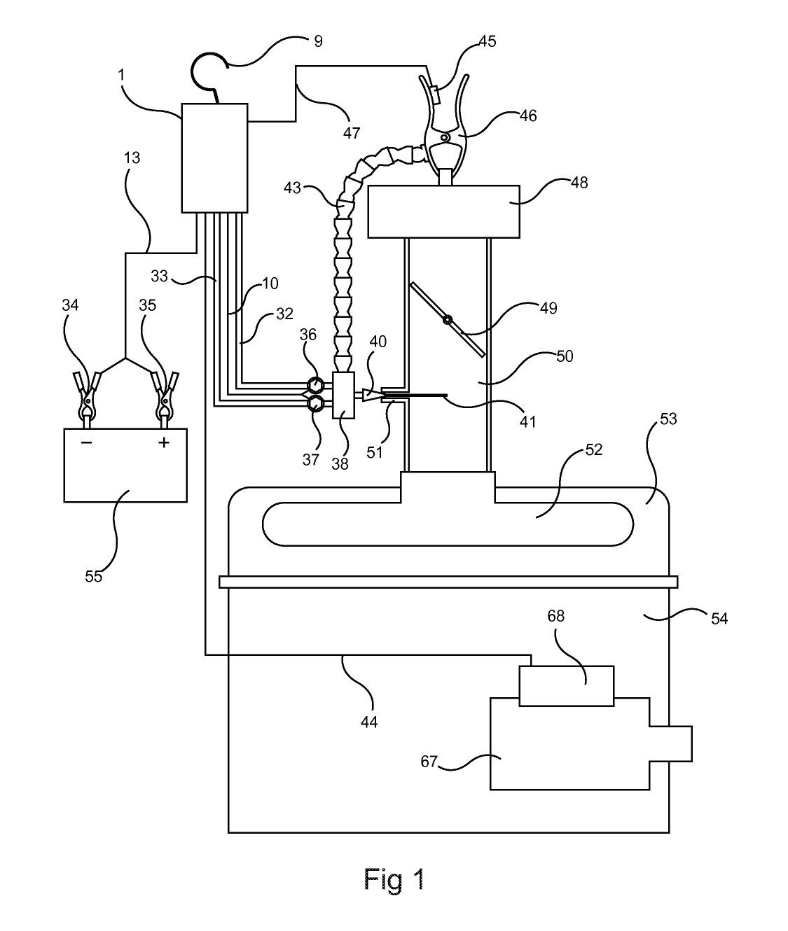

FIG. 1 illustrates the Dual Solenoid Induction Cleaner 1 working in conjunction with an internal combustion engine 54. Internal combustion engine 54 has the cylinder head 53, intake manifold 52, throttle body 50, throttle plate 49, intake opening or port (a/k/a vacuum port) 51, air filter 48, starter 67 and starter solenoid 68. Dual Solenoid Induction Cleaner 1 includes: a hook 9 to hang unit from vehicle hood; power lead 13, which supplies current to Dual Solenoid Induction Cleaner 1, is connected to vehicle battery 55 with negative clamp 34 and positive clamp 35; induction cleaner supply lines 32 and 33 connect Dual Solenoid Induction Cleaner 1 to electric solenoids 36 and 37; electric solenoids 36 and 37 supply induction cleaner to induction cleaner nozzle 41 which is placed inside induction tract through vacuum port 51 opening. In operation engine run sensor 45 (discussed in detail below) sends signal to Dual Solenoid Induction Cleaner 1 through wire 47. Once engine run signal is received Dual Solenoid Induction Cleaner 1 can discharge chemistry.

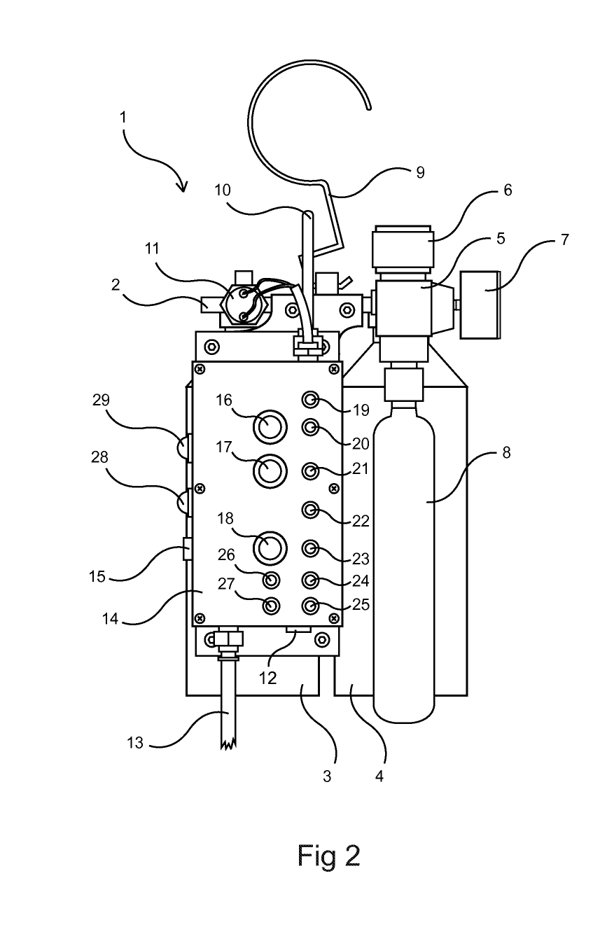

FIG. 2 shows the front view of control panel of Dual Solenoid Induction Cleaner 1. When vehicle battery (shown in FIG. 1) is connected through power lead 13 and external fuse 12 power lamp 19 is illuminated. This lets the service person know that the unit is powered and ready. To start induction cleaning, the service person will push arm/disarm button 16 in order to arm the system. If enabling criteria is present, which is that the air pressure supply level is good, the system can be armed. (The air pressure and air pressure switch can be adjusted so as to set the pressure needed for the particular chemistry being delivered.) If the enabling criteria is not present not armed lamp 28 is illuminated and audio alert (not shown) is beeped. Once the system is armed lamp 20 is illuminated. This lets service person know that the system can now discharge induction cleaning chemical.

It has been found that a chemical presoak will help remove the carbon buildup within the induction system. As with all induction cleaning chemicals, time is needed in order to break down carbon bonds. We have determined through testing that, when using some induction cleaning chemistry, if the induction cleaning chemistry is applied during an engine crank and then left to soak over time, the chemistry will start to break down the carbon bonds. The cranking time preferred is 20 seconds. This crank time is set due to the heat generated within the starter motor during long crank times. During engine cranking the engine slowly and evenly draws air into each cylinder. When the chemical is discharged during this crank period an even distribution of the chemistry can be applied within the engine. This cranking treatment will apply chemistry to the engine which includes, the intake tract (including the intake valve), combustion chamber, and exhaust valve. Once this chemical is applied and allowed to soak the chemistry starts breakdown or changing of the carbon bonds. While this soak time will vary depending on the specific chemistry used, testing has determined that a minimum of 15 minutes is necessary to start carbon breakdown with the presently available commercial carbon cleaning chemistries. After the soak period is completed it becomes much easier to remove the carbon during the engine run cleaning procedure.

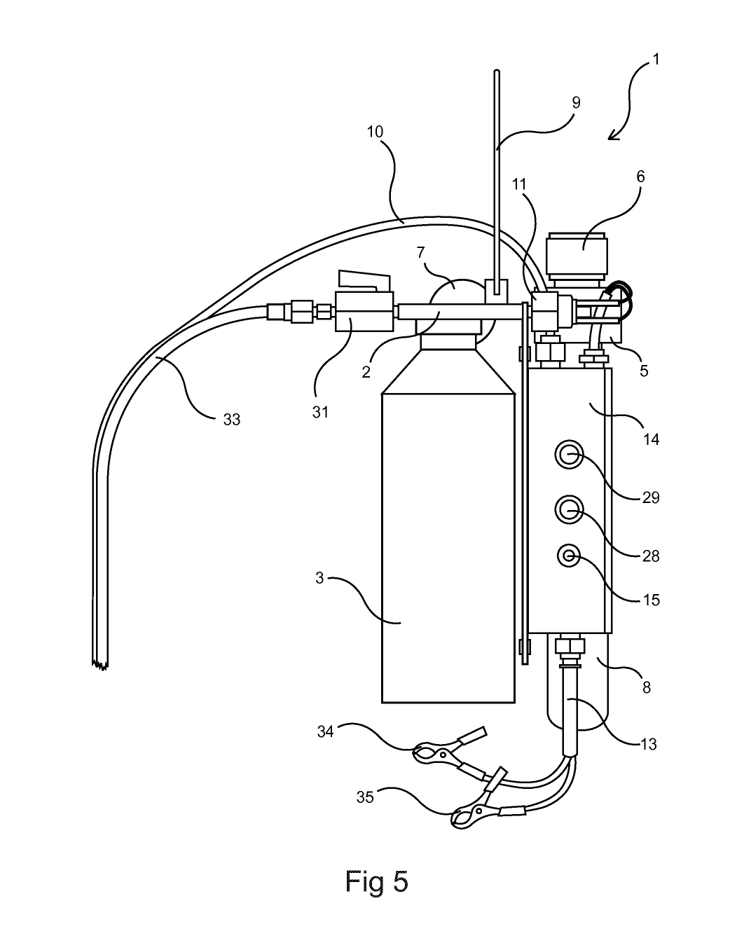

If a chemical presoak is desired, wire 44 (shown in FIG. 1) is connected from banana plug connector 15 (shown in FIG. 5) to starter solenoid 68 (shown in FIG. 1) or starter relay (not shown). The enabling criteria for crank sequence is that the air pressure level is good, vehicle battery voltage is good, and the signal is received from engine run sensor 45 indicating the engine is cranking. The Dual Solenoid Induction Cleaner has multiple alert lamps to convey information to the service person on the current operating condition of the unit. If the enabling criteria are not present, the not armed lamp 28 is illuminated and audio alert (not shown) is beeped. If enabling criteria is good when the service person pushes crank button 17 a signal of 12 volts is supplied to starter solenoid 68 (shown in FIG. 1) or starter relay (not shown) for a preferred 20 seconds. This 12 volt power output will engage the starter thus rotating the engine over or turning the engine over. At this time the crank lamp 21 is illuminated and cleaner solenoid 36 (shown in FIG. 1) is turned on, lamp 26 is turned off and lamp 24 is turned on indicating that solenoid 36 is activated. This will supply induction cleaning chemistry to nozzle 41 (shown in FIG. 1) thus supplying it into the engine as it is cranked over for the 20 second crank period. At the end of crank period cleaner solenoid 36 is turned off as well as lamp 24, and lamp 26 is turned on indicating that solenoid is off. Additionally crank lamp 21 is turned off. Once the crank period is done, soak time lamp 22 is illuminated for a preferred 15 minutes. At the end of the 15 minute soak period the soak lamp 22 is turned off and audio alert (not shown) is beeped to let the service person know the soak period is done. If the service person wants to run additional presoaks the crank button 17 is pushed and the crank sequence is run over again.

The engine is now started and the service person will push the start clean button 18. The enabling criterion for the start clean sequence is the air pressure level is good and a signal is received from engine run sensor 45, indicating the engine is running. If the enabling criteria is not present not armed lamp 28 is illuminated and audio alert (not shown) is beeped. If enabling criteria is good the system will start to deliver induction cleaner for, for instance, 30 seconds. When the cleaner solenoid 36 (shown in FIG. 1) is turned on lamp 26 is turned off and lamp 24 is turned on, indicating the solenoid 36 is activated. At the end of this 30 second period the cleaner solenoid 36 is shut off and a non injection period is started. This non injection period is run for, again for instance, 30 seconds. When the cleaner solenoid 36 is turned off lamp 24 is turned off and lamp 26 is turned on, indicating the solenoid is off. At the end of this 30 second period solenoid 37 (shown in FIG. 1) is turned on for, for instance, 30 seconds. When solenoid 37 is turned on lamp 27 is turned off and lamp 25 is turned on, indicating the solenoid 37 is activated. At the end of the 30 second period solenoid 37 is turned off and a non injection period is started. Again, this non injection period is run for 30 seconds. When solenoid 37 is turned off lamp 25 is turned off and lamp 27 is turned on, indicating the solenoid 37 is off. This clean sequence is run over and over for a period of, for instance, 25 minutes. At the end of the 25 minute clean time the finished lamp 29 is illuminated and audio alert (not shown) is beeped to let service person know that the clean time has been completed.

It is important to understand that these time stage sequences can be altered for different chemistries. Different chemistries will need different time sequences in order to allow them to work to their maximum capability. Also the amount of chemical weight delivered to the engine can be changed for different chemistries in order to allow them to work to their maximum capability. Additionally more than two chemistries could also be used. During the testing of the Dual Solenoid Cleaner up to four different chemistries have been used. This required four different reservoirs in order to deliver the four different chemistries to the engine. Through testing it was determined that the use of what is sometimes referred to as first chemical cleaner and a second chemical wash provided the best results. These chemistries, called first chemical cleaner and second chemical wash, are just different chemistries that interact with one another quite well. These chemistries are chosen by the results of the interaction between the carbon and the chemistries themselves. Regardless of how much is delivered, the interaction of the chemistry with the carbon is important. If a large amount of a particular chemistry was used that did not work no carbon would be removed. Thus, the formulation of the chemistries used cannot be ignored.

The chemical nature of carbonaceous engine deposits varies somewhat depending on their location in the engine, which is largely a factor of deposition history, (e.g., temperature, combustion, amount of re-exposure to liquid). Although the deposits typically consist primarily of polynuclear aromatic hydrocarbon species, there are also aliphatic species that may be alkanes or alkenes and have varying degrees of oxygenation. The nature of the hydrocarbon mixture will depend, again, on the deposit location and deposition history. It is known that different solvent types, concentrations and combinations attack the various hydrocarbon types to varying degrees and that, furthermore, the efficacy of their effect is also a function of temperature, pressure, and exposure time. The latter is of particular importance when considering the Dual Solenoid Induction Cleaner run profile (discussed below) as well as knowledge of the specific chemical action performed on the various deposits by the various chemistries used.

In general, there are three types of carbon deposit cleaning solvents. (1) Non-Specific Solvents that remove the relatively small amount of waxy and resinous parts of the deposits based solely on solubility parameter interaction. These types of deposit materials typically occur in cooler areas of the engine, such as at the injector tip, and their removal can create larger pore volume in the remainder of the deposit that may be swelled by other, more aggressive solvents. Examples of non-specific solvents include acetone, alcohols, and ethers. (2) Specific Solvents that cause physical dissolution via electron density mediated disruption of non-covalent bonds. These solvents induce deposit swelling and will remove some fraction (approximately 20-40%) of the deposit that is chemically indistinguishable from the remainder of the deposit. Specific Solvents are typically molecules that contain a nitrogen atom and an oxygen atom with an unshared electron lone pair. Pyridine is an example of a Specific Solvent. (3) Reactive Solvents that cause deposit degradation by covalent bond cleavage. The chemical structure of both the solvent and the deposit may be altered as a result of the interaction. Reactive Solvents for carbon removal are generally either alkaline hydrolysis compounds/mixtures or dipolar aprotic ‘super solvents’. An example of a super solvent is methyl pyrrolidones such as NMP.

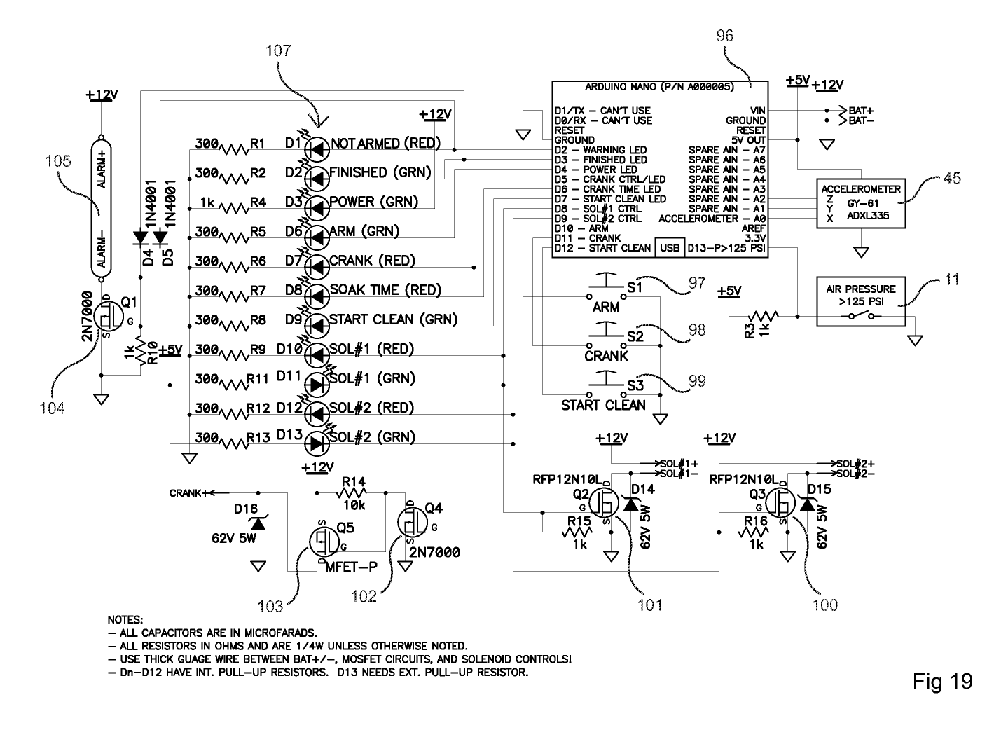

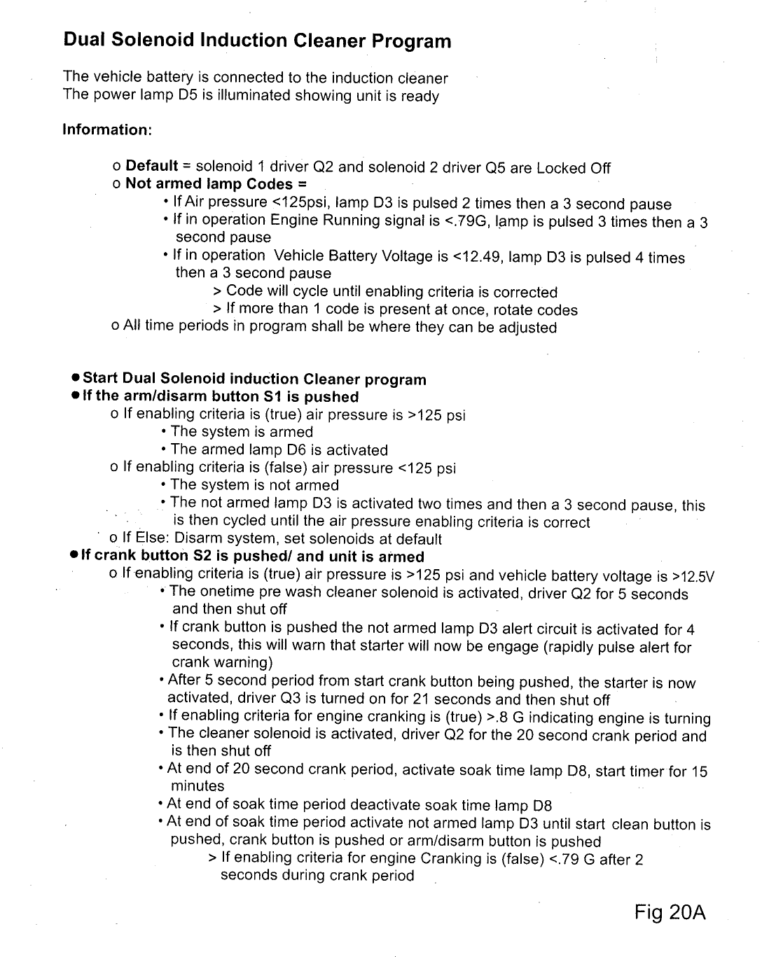

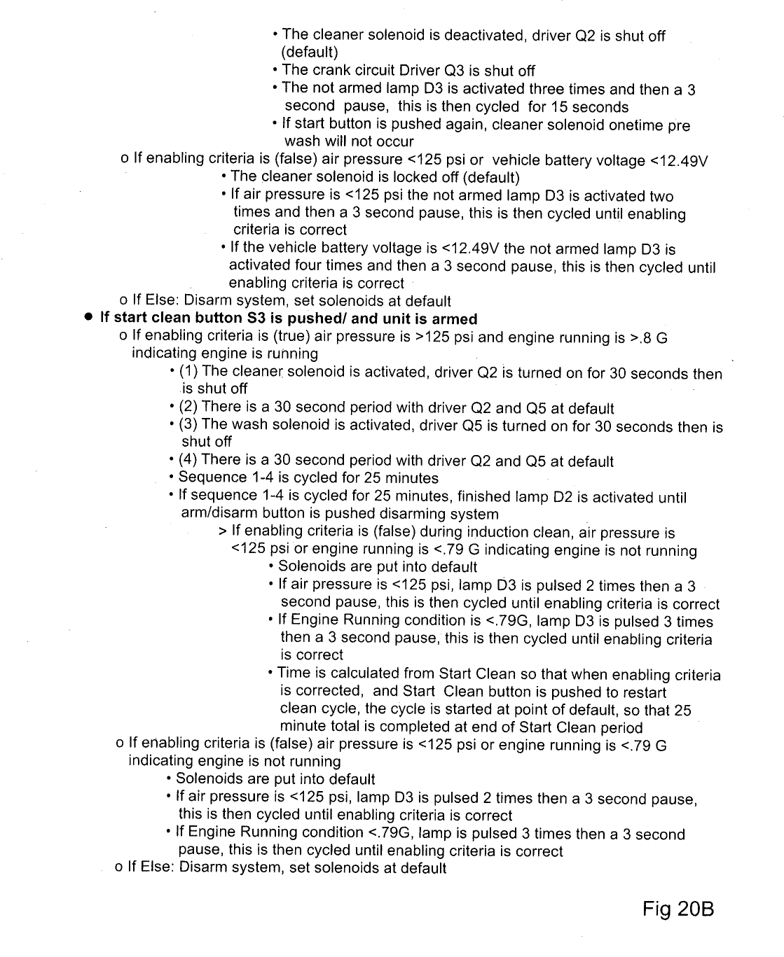

It is important to know the nature of the chemistry that will be used so the microprocessor 96 (described below in conjunction with FIGS. 19 and 20) can be programmed for the run profile for the specific chemistry that will be used. This ability to program the Dual Solenoid Induction Cleaner to the chemistry/chemistries that are to be utilized is important in a number of different applications. The time the solenoids are turned on applying chemistry to the induction tract can be changed along with the time the solenoids are turned off. These on-off periods will change the way the chemicals will work. Once the chemistry is applied to the induction tract the chemistry off time will allow such chemistry the needed soak time in order to break the carbon bonds. (And, as discussed above, with this soak time pause the catalytic converter temperature and/or turbocharger temperature can be maintained, thus protecting it from damage.) This will allow the chemicals to work to their maximum capability. These carbon deposits are extremely difficult to remove and every advantage is needed in order to remove them from the internal combustion engine.

During testing of the Dual Solenoid Induction Cleaner the chemistries were layered, changed or alternated between different chemistries, and different time sequences determined using manual shut off valves and a stop watch. The engines being tested were checked with a borescope before any induction cleaning was done. Then the engines were cleaned with different chemistries and different timed sequences. After each of the cleaning processes the engines were re-inspected with the borescope. The result of how much carbon was removed from the engine with each of the chemistries and time sequences was then taken as data. This data was then used to design the Dual Solenoid Induction Cleaner. The manual shut off valves and a stop watch provided a quicker way to collect data from engines that had been cleaned. This data was then analyzed and the Dual Induction Cleaner run profiles, where the “first run time”, and the “second run time”, the “pause time”, and the number of cycles (or the cycle time) were then programmed. Additionally, run profiles can be programmed where only a single chemistry is to be used. All such run profiles can be stored in the microprocessor. However, if the Dual Induction Cleaner is set up to run only certain, preselected chemistries, microprocessor 96 need only store the run profiles that can be used for such preselected chemistries. The use of manual shut off valves and a stop watch also demonstrates that these timed stage sequences can be accomplished manually, without a microprocessor or other electronic controls. Thus, anyone versed in the art could manually control these chemical delivery sequences to accomplish the same results.

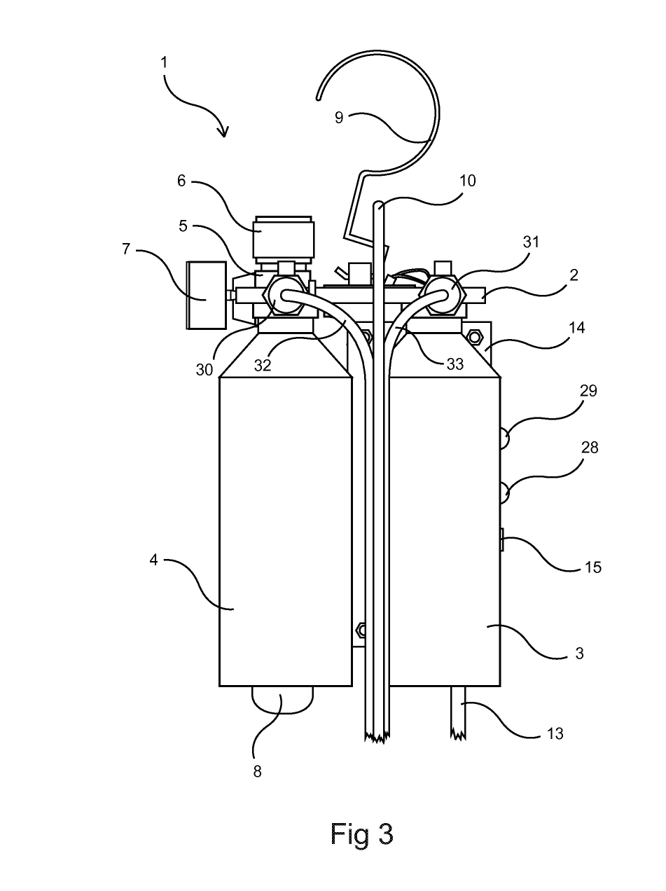

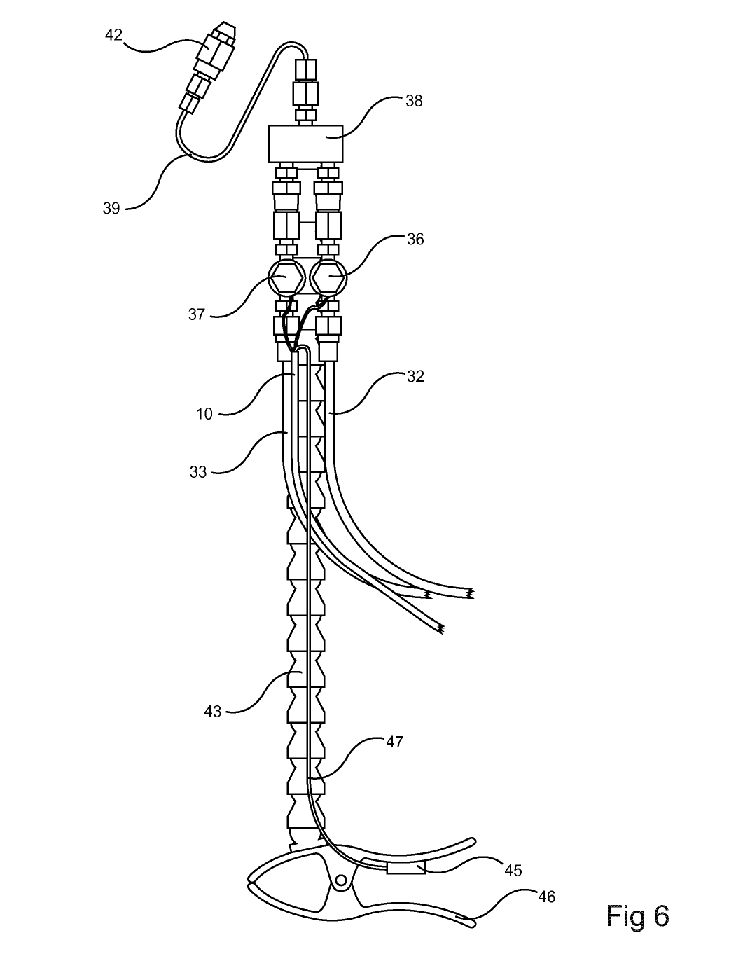

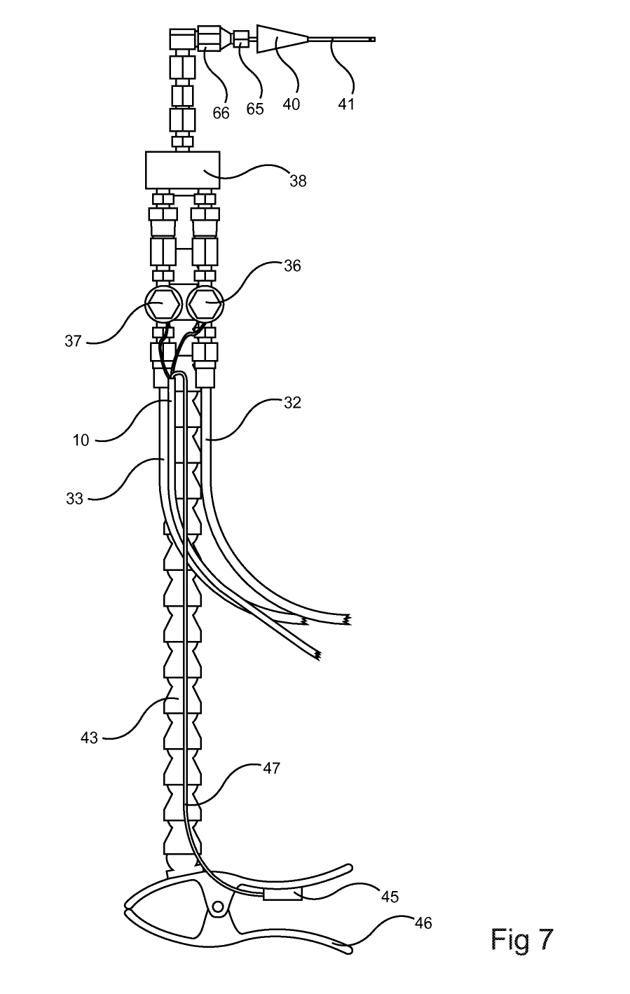

FIG. 3 shows the back view of the Dual Solenoid Induction Cleaner 1. The base 2 holds the chemical cleaner reservoir 4 and chemical wash reservoir 3. The cleaner supply line 32 is connected to base 2 with a manual shut off valve 30 and is isolated from wash supply line 33 which is connected to base 2 with a manual shut off valve 31. Control wire harness 10 runs from microprocessor (not shown but is held in housing 14) to injector solenoids 36 and 37 shown in FIGS. 6-7. Additionally, harness 10 carries wires for engine run sensor 45 (shown in FIG. 1).

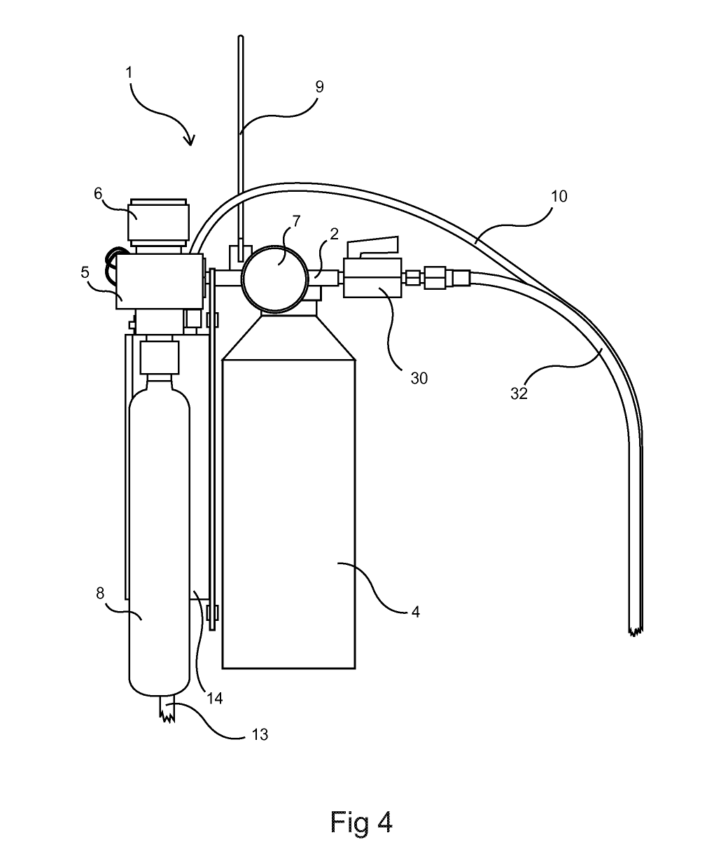

FIG. 4 shows the right side view of the Dual Solenoid Induction Cleaner 1. The air pressure supply can be of two different types. If the vehicle is being cleaned where there is no compressed air available a 90 gram CO2 cartridge 8 is used. Alternately, if compressed air is available an air hose (not shown) from an external air compressor is used. This air pressure is fed into air pressure regulator 5, which is connected to base 2 and supplies pressurized air for the operation of the Dual Solenoid Induction Cleaner. Air pressure regulator 5 is adjusted with adjustment knob 6. As the air pressure regulator 5 is adjusted pressure gauge 7 connected to base 2 will show the actual air pressure within reservoirs 3 and 4.

FIG. 5 shows left side view of the Dual Solenoid Induction Cleaner 1. Adjustable air pressure sensor 11 sends signal to microprocessor (not shown) but located in housing 14. Banana jack 15 supplies an output of 12 volts to starter solenoid 68 (shown in FIG. 1) or start relay (not shown). Not armed lamp 28 is turned on when enabling criteria is not correct. Not armed lamp 28 will pulse a code to let the service person know which of the enabling criteria is not present. Two pulses indicate that the air pressure is less than the set value; three pulses indicates that the run sensor signal is incorrect; and four pulses indicates the vehicle battery voltage is low. Finished lamp 29 is turned on when induction cleaning cycle is finished. Power harness 13 is connected to vehicle battery 55 (shown in FIG. 1) with negative clamp 34 and positive clamp 35. Power from harness 13 is feed through removable fuse 12 (shown in FIG. 2).

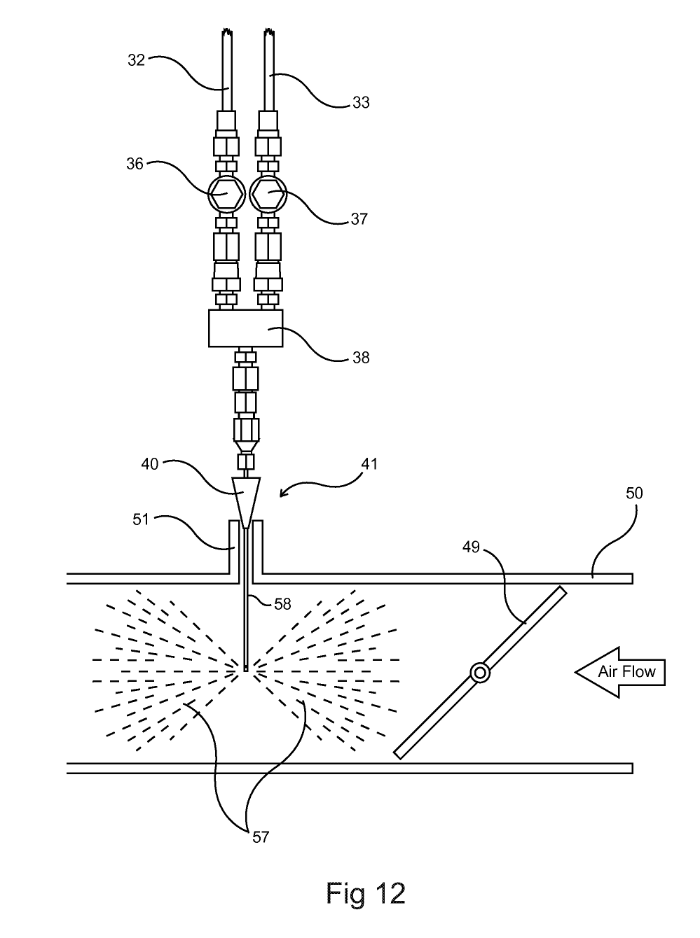

FIGS. 6-7 shows solenoid 36 and solenoid 37. These solenoids control the induction cleaning chemistries that are supplied through cleaner block 38 and tube 39 to conventional fuel oil burner nozzle 42, or through cleaner block 38 to novel induction cleaner nozzle 41 (discussed below in conjunction with FIGS. 12-16B). Cleaner block is supported by flex support tube 43 that is clamped to engine by clamp 46. When clamp 46 is locked to engine 54, engine run sensor 45 picks up vibrations from the engine. The engine run sensor is a conventional accelerometer which sends a signal to the microprocessor that the microprocessor (96 in FIG. 19) utilizes to interpret the engine running state condition. This sensor reads the vibrations produced when the starter motor is cranking the engine over and when fuel is ignited in the running engine. The accelerometer senses the engine running condition which is: engine off, engine cranking, and engine running. If the correct signal is not received by the microprocessor from the engine run sensor, the microprocessor will lock out solenoids 36 and 37. With these solenoids locked out chemistry will not be delivered to the engine.

In the past the ignition discharge was used for determining if the engine was running. However on modern vehicles it is extremely difficult to connect to the ignition system on the vehicle. Thus, the novel method described herein was developed. After testing different methods and using different sensors in order to determine if the engine is running, the accelerometer was found to provide the best results for this application. However, many other types of sensors which read the vibrations, oscillations or air pressure pulses from the engine (such as a microphone, tailpipe pressure transducer, crankcase pressure transducer, or induction pressure transducer) could also be used for the engine run sensor. Also, as those skilled in the art will appreciate, such an engine run sensor can be used controlling other engine testing and/or maintenance procedures based in part on the signals from such a sensor.

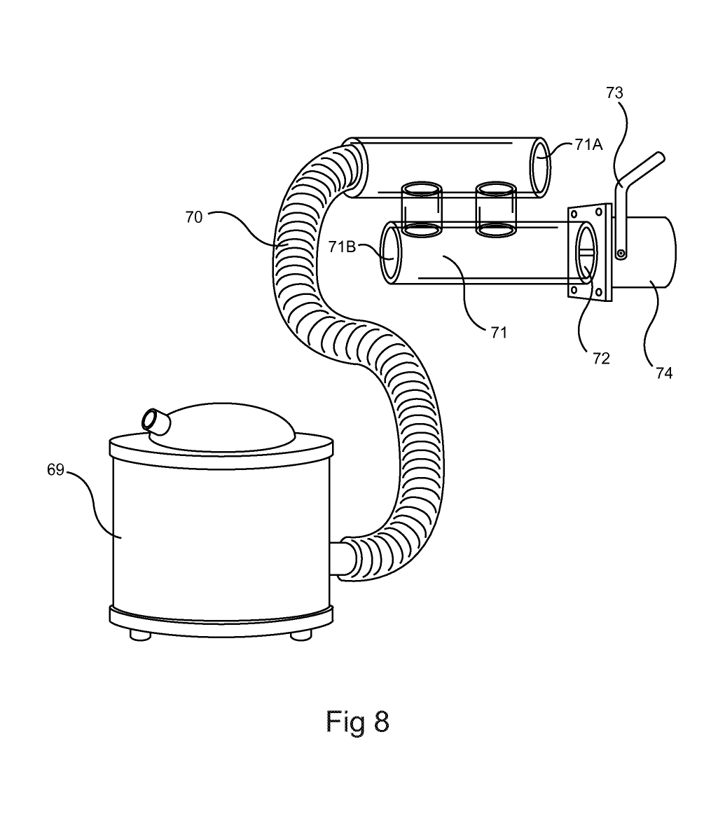

In order to observe the chemistry delivery from various nozzles an apparatus was built as shown in FIG. 8. An industrial 6.5 HP wet and dry vacuum 69 is connected with hose 70 to one end of a clear acrylic plastic tube set 71 that is sealed on ends 71A and 71B. A throttle body 74, with a throttle plate 72, and throttle control lever 73, from a vehicle is mounted to the other end of clear acrylic plastic tube set 71. The vacuum system 69 is turned on and the various types of nozzles (e.g. conventional oil burner nozzle, air bleed nozzle, and the novel induction cleaner nozzle disclosed herein) were tested for actual delivery. Due to the toxic nature of induction cleaning chemicals, water (being of similar viscosity to induction cleaner) was used. The droplet sizes, puddling, and the ability for the droplets to stay suspended in the moving air column were then observed.

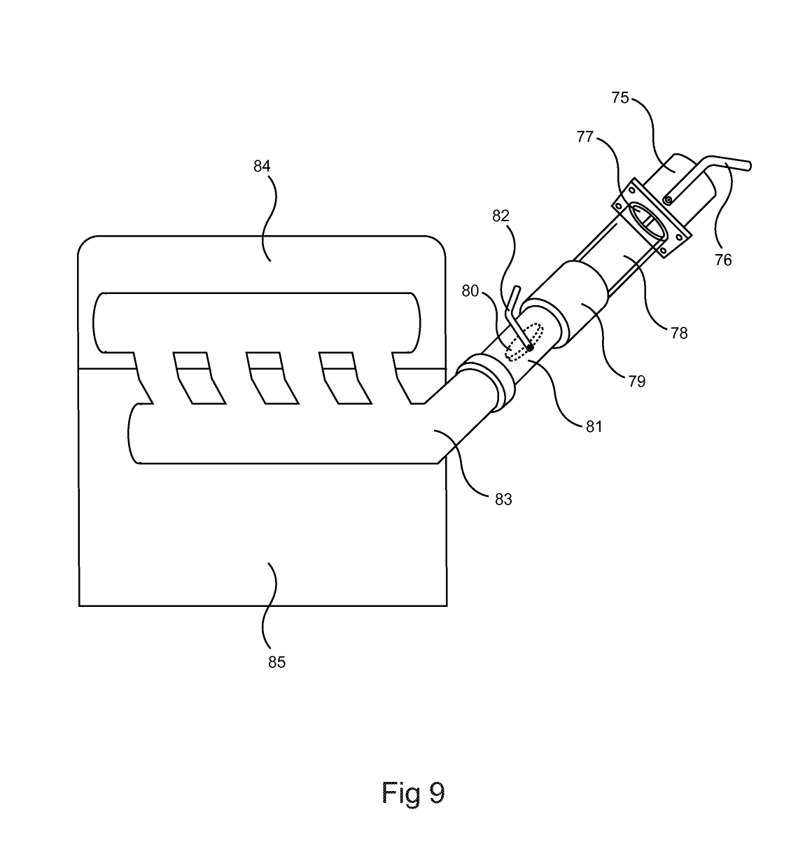

Once the testing was concluded with the wet and dry vacuum, an apparatus was built as seen in FIG. 9 that attached to an internal combustion engine. A throttle body 75 with a throttle plate 77 and throttle control 76 from a vehicle was attached to a clear acrylic plastic tube 78. The clear acrylic plastic tube 78 was connected with a rubber hose 79 to the vehicle's throttle body 81. The throttle plate 80 in throttle body 81 was held at wide open throttle with throttle control 82. The air was allowed to be metered into the engine with throttle body 75. The different nozzles (e.g., conventional oil burner nozzle, air bleed nozzle, unique induction cleaner nozzle) were then connected and observed for droplet size, puddling, and the amount of droplets that remain suspended in the moving air column.

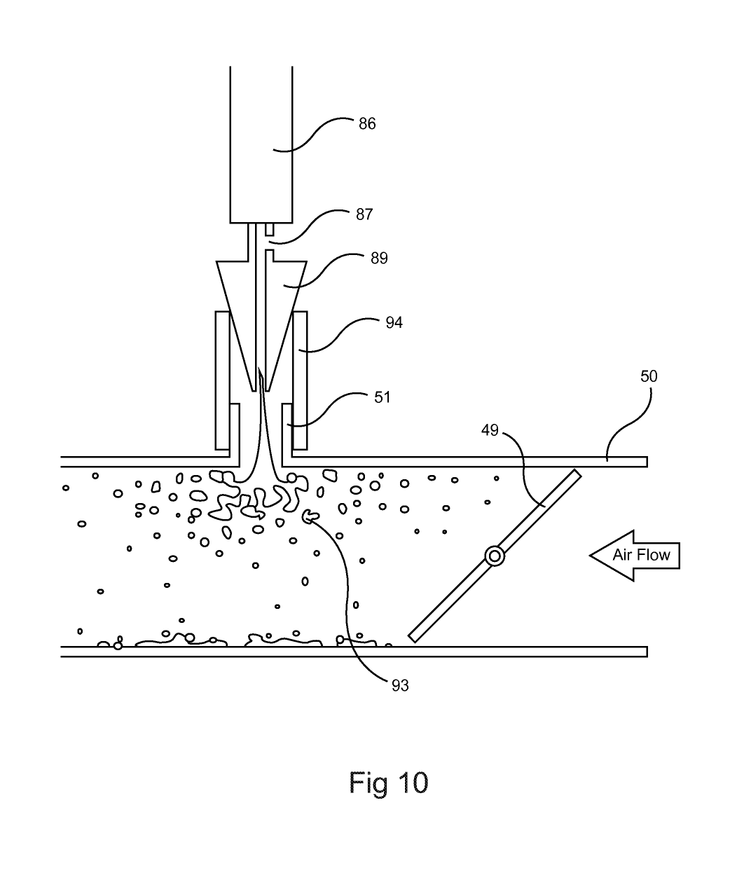

Different prior art nozzles were tested in conjunction with the apparatus illustrated in FIGS. 1-7 and the delivery of induction cleaning chemistries in timed intervals as disclosed herein. FIG. 10 illustrates the use of an air bleed nozzle, such as disclosed in FIG. 4B in U.S. Pat. No. 6,530,392 B2 issued to Blatter. This nozzle works by using the low pressure of the engine to pull the chemistry from a reservoir (not shown) through the engine vacuum port 51 into the induction system. As the chemistry is pulled from the reservoir through delivery tube 86 air is bled through hole 87 and is mixed with the chemistry in discharge nozzle 89 connected with vacuum hose 94 to vacuum (or intake) port 51. This delivery system makes a very uneven spattering 93 of the chemistry as it is discharged into the intake tract. This chemical spattering 93 creates large droplet sizes that tend to fall out of the air column and create puddling in the intake tract as illustrated. Wide Open Throttle (WOT) snaps, not disclosed by Blatter, will help create turbulence that will break these puddles up and carry more of the chemistry/chemistries into the engine. However, the throttle cannot be held in its wide open position for the duration of the cleaning process without causing engine damage. Notwithstanding the drawbacks of the Blatter nozzle, its use in conjunction with the staged delivery of chemistry/chemistries as disclosed herein, increased the amount of carbon removed from the induction system.

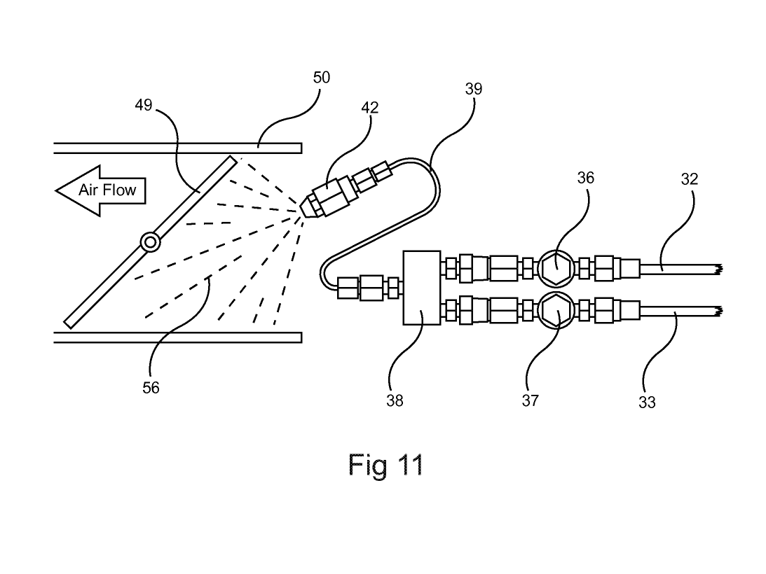

FIG. 11 illustrates the use of a conventional oil burner nozzle 42 with pressurized reservoirs such as illustrated in FIG. 3 to supply the nozzle 42 with chemistries. Oil burner nozzle 42 can have many different flow rates and discharge angles. Regardless of which type of oil burner nozzle is used, the methodology of the present invention requires the nozzle position to be in front of the throttle plate 49. In this position the discharged chemicals 56 from the nozzle 42 will hit the throttle plate 49 and throttle body 50 causing the chemical to impinge on the parts. Once the discharge chemical 56 has contacted the throttle plate 49 or throttle body 50 sides, some of the small droplets created by the oil burner nozzle will run to the edge of the throttle plate 49 where they will congeal. More specifically, the droplets will move around the plate where some will slide on to the back of the throttle plate 49 and become larger in size before they move into the moving air. The air flow moving past the throttle plate edge will move some of the droplets into the engine. However, many of these congealed droplets will tend to puddle in the intake floor. WOT snaps will help create turbulence that will break these puddles up and carry the cleaner into the engine. Additionally during WOT snap events, the cleaner does not hit the throttle plate and the aerosol droplets created by the oil burner nozzle will be carried to the carbon sites. The problem here, as discussed above, is that the snap throttle event is for a very short time. When using the oil burner nozzle in an internal combustion engine without a throttle plate, such as some gasoline engines and most diesel engines, there is no throttle plate to obstruct the chemical delivery. In this situation the chemistry will stay suspended in the moving air. However the droplet sizes are so small that the chemistries tend to flash into a vapor state. (This is because oil burner nozzles are designed so that the oil would be changed from a liquid to a vapor in order for the oil to burned and produce heat in a furnace.) And, once the induction cleaning chemistry is changed from a liquid to a vapor the chemistry will not work as well. It is important to also understand that an electric injector such as, but not limited to, an automotive style injector could be used in place of the electric solenoid and oil burner nozzle. With this electric automotive style injector similar results could be obtained.

FIG. 12 illustrates induction cleaner nozzle 41 which has been designed to overcome the limitations of prior art nozzles, such as described above. While the overlaying techniques of the present invention work with prior art nozzles (e.g., an oil burner nozzle), due to limitations such nozzles have with regard to droplet size including vaporization, chemical impingement, and puddling within the induction tract the chemistry cannot reach all of the carbon sites. And, if the chemistry does not reach the carbon, it cannot be removed. However with the unique induction cleaner nozzle 41 design parameters the droplet configuration, puddling, and chemical impingement problems are overcome. The induction cleaner nozzle 41 uses a pressurized reservoir (e.g., FIGS. 2-3) to supply nozzle 41 with chemistry. Cleaner nozzle 41 includes a tube 41A that is small enough to slip through the inside of the vacuum port 51. This will allow the chemistry to be directly delivered as small droplets (e.g., an aerosol spray) 57 into the moving air column as illustrated in FIG. 12. The preferred tube size is 0.125 of an inch which has been determined to fit through most vacuum ports on modern engines. Since the chemistry is delivered under pressure the droplet size can be controlled and maintained to a very small size. This very small droplet size allows some of the chemical to fall out of the air column without puddling with the remainder suspended within the air column to continue movement down the induction system where more of the chemistry will come into contact with more carbon sites. The chemistry droplet sizes are very important. If the droplets are too large the chemical may tend to fall out of the moving air flow through the induction system right away, thus not wetting all of the carbon sites. If these droplets are too small the chemicals may tend to vaporize, thus the carbon sites cannot be effectively wetted. In either of these scenarios the carbon may not be removed from all areas of the induction system. (Again, it is best to wet the carbon with the liquid chemistry in order to remove it.) Additionally the spray 57 does not come into direct contact with the throttle plate 49 or throttle body 50 allowing it to remain suspended within the moving air column. This allows the chemistry to reach all the carbon sites within the induction tract, thus more carbon can actually be removed than with the use of the prior art nozzles.

During development of nozzle 41 many different nozzle types were built and tested. It was found that a straight tube that is open on both ends and is inserted into air bleed nozzle 89 (air bleed nozzle is illustrated in FIG. 10) will improve chemistry delivery. With this delivery device the liquid chemistry will be discharged into the middle of the moving air column (instead of being discharged at the end of the vacuum port on the side of intake track as illustrated in FIG. 10), which allows more of the liquid droplets to remain suspended. It was also found that a straight tube that is open on the end inserted in the middle of the moving air column with an array of very small openings worked well with a vacuum pull delivery system. When the tube with very small openings was placed through the vacuum port (as illustrated in FIG. 12) the low pressure from the engine pulled the chemistry from a reservoir, which is under atmospheric air pressure, into the intake tract. As the chemistry moves from the nozzle opening into the intake tract the droplets that are produced shear into small droplets that remain suspended within the moving air column. Additionally a tube with very small openings was found to work well with a pressurized reservoir. The pressure forces liquid through the very small openings that form liquid streams, these steams break up into smaller droplets within the moving air column.

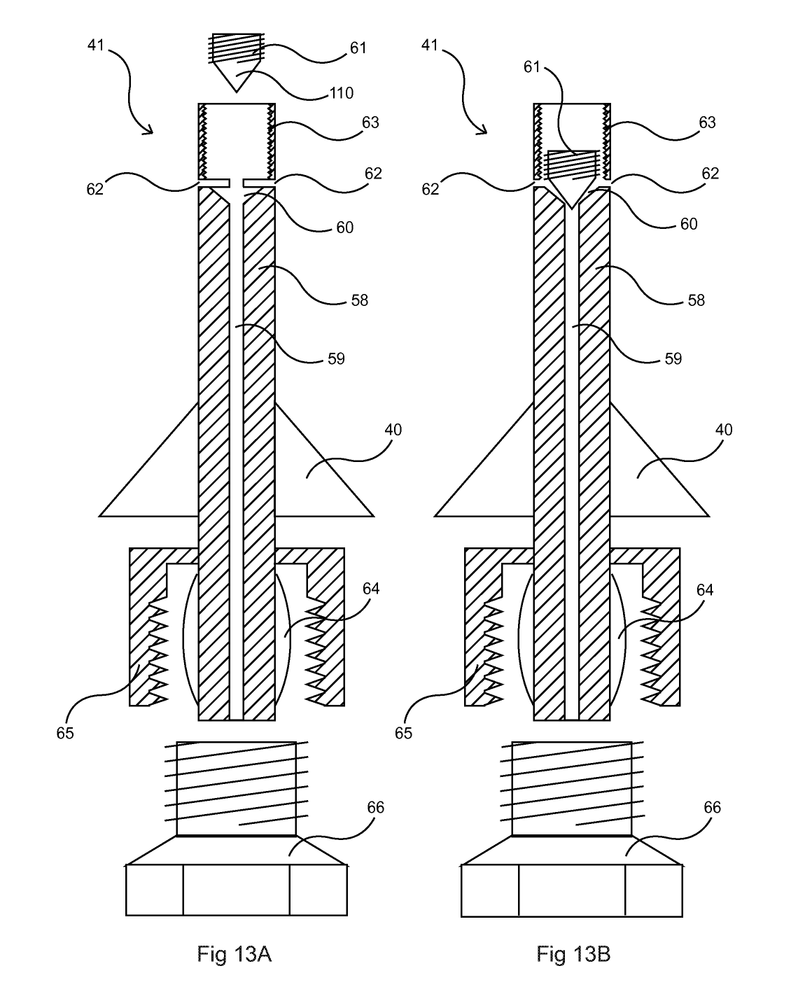

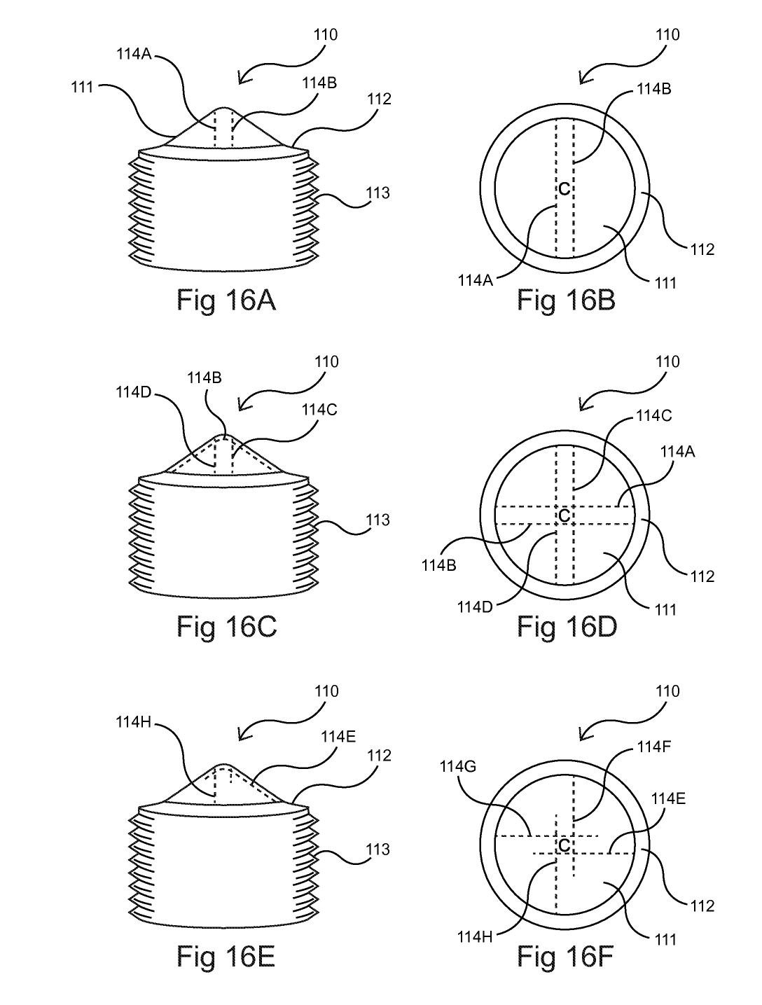

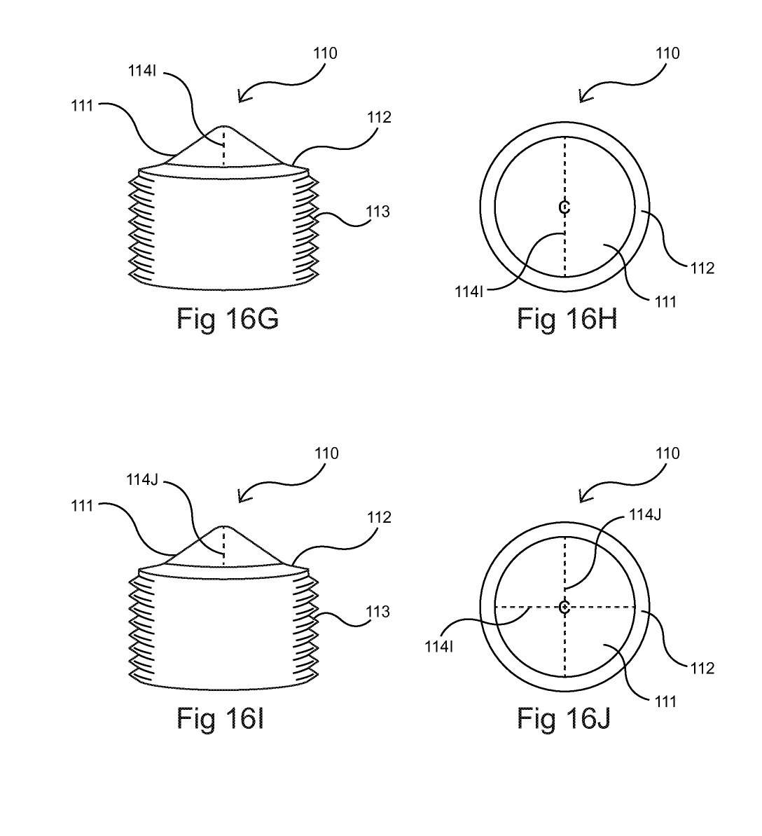

The preferred design for the induction cleaning nozzle 41 is shown in FIGS. 13A and B. In this design tube 58 is held by bushing 64 and bushing nut 65 to mounting nut 66. Mounting nut 66 also has a porous brass filter in it (not shown) to filter impurities from the induction cleaning chemicals being used. Tapered vacuum seal 40 slides on tube 58 in order to seal tube 58 to the vacuum port on engine. This also allows the depth of tube 58 to be adjusted into intake tract. Tube 58 has passage 59 that delivers induction cleaning chemistry to openings or slots 62. As the chemistry is moved through passage 59 it comes in contact with the cone shaped surface 110 of tapered screw 61 (discussed in greater detail in conjunction with the discussion of FIGS. 16A-J). Tapered screw 61 fits into angled outlet 60 which is a seat for surface 110. This fit between surface 110 and angled outlet 60 sets up a restriction that the pressurized liquid pushes against. The threads 63 allow tapered screw 61 to be adjusted into angled outlet, thus setting up the desired restriction. As the liquid moves through this restriction the pressure drops and the liquid is forced through slots 62. There are two slots placed on tube 58, one on each side.

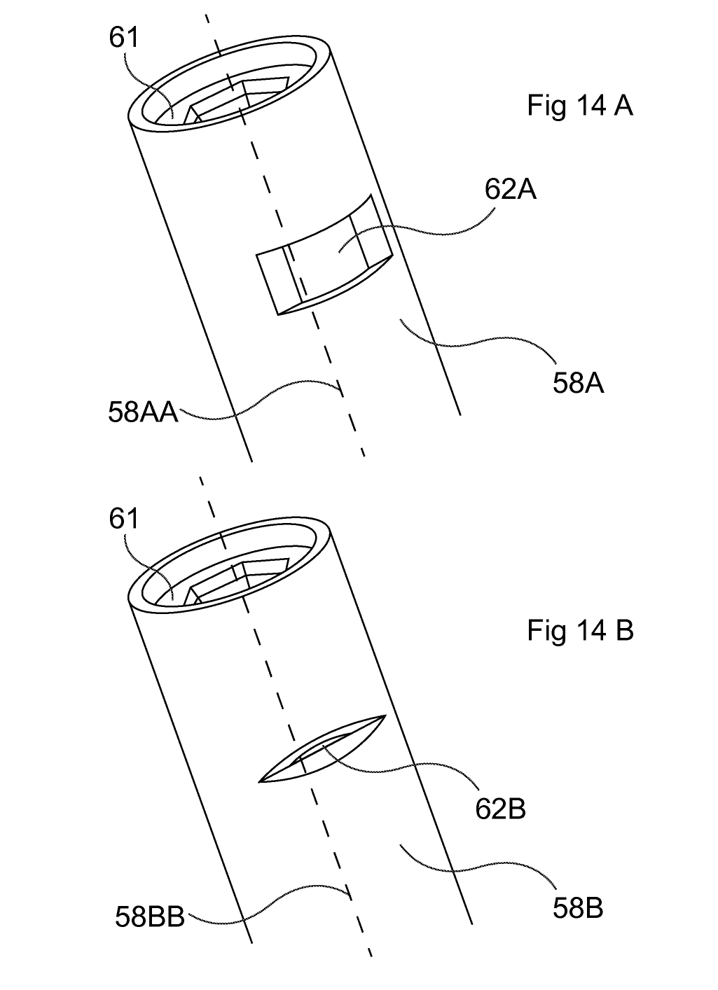

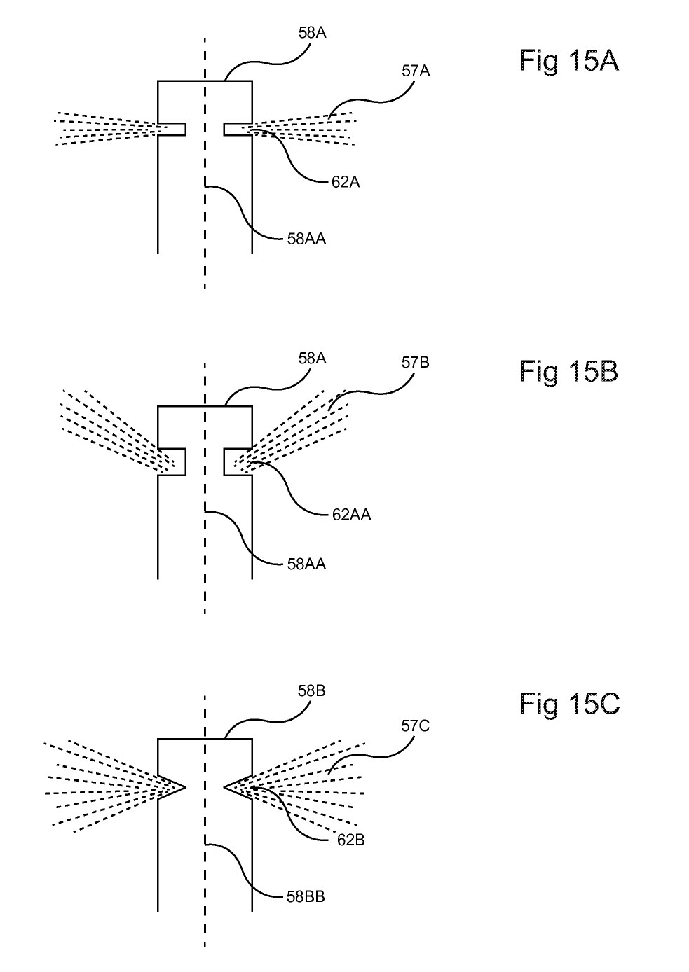

In FIGS. 14A and B, 15A, B and C, 16A-J, 17 and 18A and B several different discharge orifice (i.e., slot) and tapered screw designs are shown. With reference to FIGS. 14A and B, slot 62A shows a rectangular opening in tube 58A (including a longitudinal axis 58AA) that has tapered screw 61 at end of tube 58A. Slot 62B shows a fish mouth opening in tube 58B that also has tapered screw 61 at end of tube 58B. By changing this discharge orifice design the shape and direction of the chemical discharge from nozzle 41 is also changed. The discharge slot width can be made smaller or larger which will also change the liquid discharge from nozzle 41. In FIGS. 15A, B and C several different spray patterns are demonstrated from several different slot designs. In FIG. 15A the narrow slot 62A is used, with this design the spray pattern 57A projects from tube 58A with a trajectory generally perpendicular to axis 58AA. In FIG. 15B a wider slot 62AA is used, which results in the spray pattern 57B projecting from tube 58B with an angled trajectory. In the slot design and associated testing, the size of the slot (e.g., slot 62A) in the dimension parallel to the longitudinal axis of the tube has ranged from 0.040 to 0.006 inches. In FIG. 15C the fish mouth slot 62B is used With this design the spray pattern 57C projects from tube 58B with a perpendicular trajectory that has a wider angle than that obtained from the use of slot 62A.

In FIGS. 16A-J several different tapered screw designs are shown. The illustrated engraved line designs (e.g., 114A and 114B) will change the discharge droplets configuration With reference to all 6 figures, surface 110 includes a cone shaped portion 111 surrounded by a donut shaped shoulder 112. Threads 113 are designed to engage with threads 63 shown in FIGS. 13A and B. FIG. 16A shows a side view of the tapered screw where lines 114A and B are engraved across the face of cone 111. FIG. 16B shows an overhead view of the tapered screw. FIGS. 16C and D show the top and side view of the tapered screw where surface 110 has 4 lines (114A, 114B, 114C and 114C) are engraved across the face of the cone shaped portion 111. FIGS. 16E and F show a side and top view of the tapered screw where 4 lines (114E, 114F, 114G and 114H) are engraved across the face of the cone shaped portion 111. FIGS. 16G and H show the side and top view of the tapered screw where groove 114I is engraved across the face of the cone. FIGS. 16I an J show an overhead and side view of the tapered screw where lines 114I and J are engraved across the tapered cone. With each line design the droplets are slightly changed as they emerge from the slot(s) (e.g., slots 62 in FIGS. 13A and B, and slots 62A in FIG. 15A). Additionally these lines, channels or grooves can be produced with a laser or can be machined on to the tapered screw cone. However when the lines are made with an engraver the line surface is rough and uneven which helps the liquid breakup and form droplets.

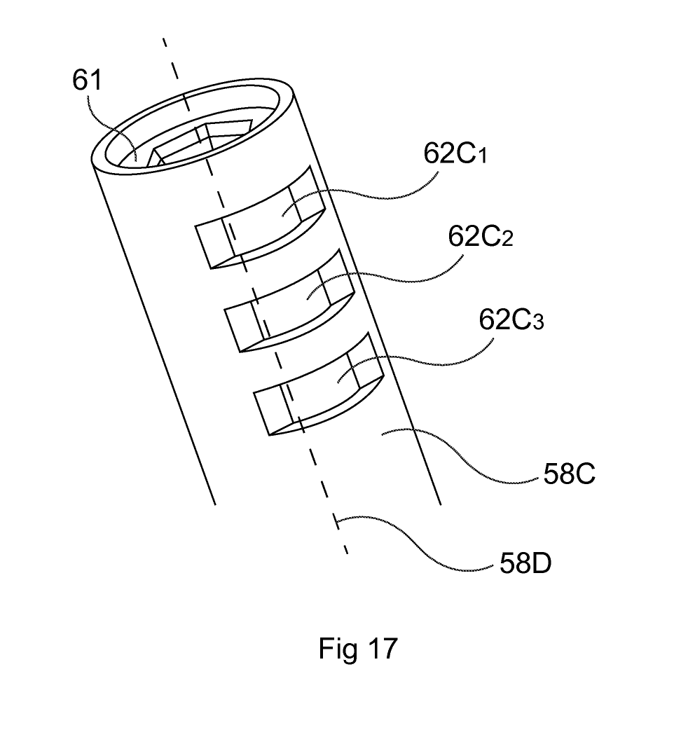

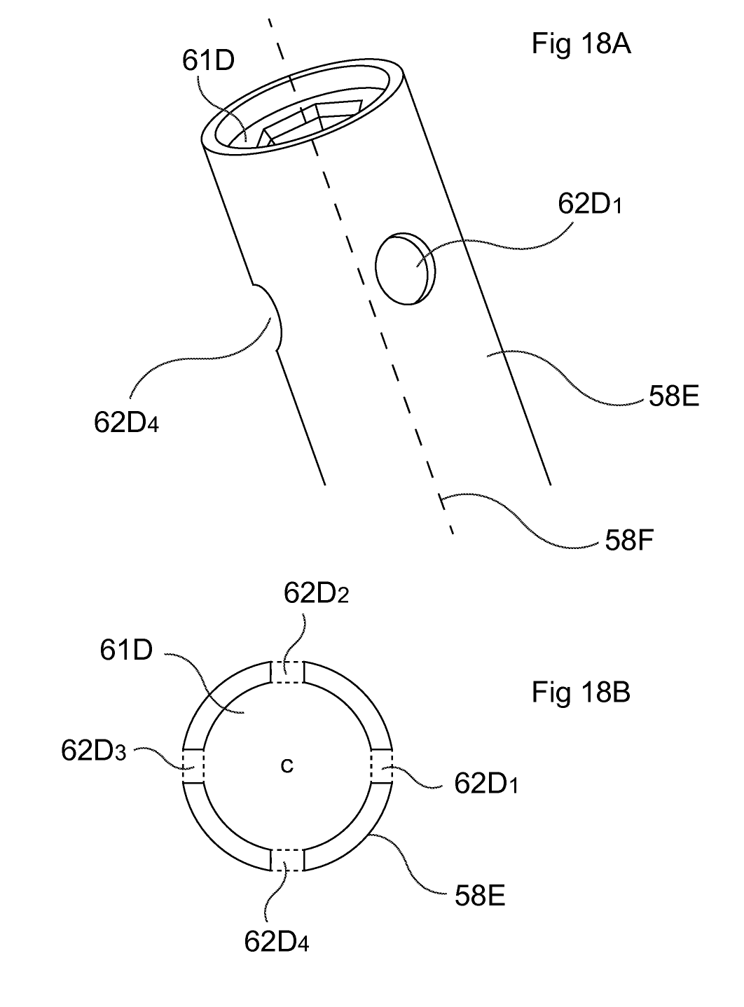

With reference to FIG. 17, tube 58C has a series of slots 62C1, C2 and C3 which are aligned vertically and substantially parallel to longitudinal axis 58D. This style slot design would be used with a vacuum pull system. With reference to FIGS. 18A and B, tube 58E has a series of slots or holes 62D1, D2, D3 and D4 which lie in a plane which is substantially perpendicular to axis 58F. As tapered screw 61D threads into tube 58F it comes close to seat on interior tube seat 60 (see FIG. 13B). The four slots or holes 62D1, D2, D3 and D4 are machined through the wall of tube 58E to the interior tubing channel right above the taper screw seat. Again, see FIG. 13B. With this arrangement, the chemical has an even disbursement all the way around the nozzle tube assembly. Further, with reference to arrangement of slots as shown in FIGS. 18A and B, there is no preferred rotational position of tube 58E about its longitudinal axis when positioned in the induction system. The initial orientation of the chemistry as it exits the slots will be in a plane substantially perpendicular to axis 58F and have a spray pattern such as illustrated in FIG. 12. The tapered screw orifice restriction and the gas pressure will determine the overall flow rate of the chemistry through the nozzle.

Thus, those skilled in the art will appreciate the design details of nozzle 41 can be varied to maximize the ability to delivery chemistry to all interior surfaces of the induction system. They should appreciate that size of the droplets and the spray pattern are affected by factors such as the particular chemistry used (and its associated viscosity and flash point), the chemistry delivery pressure, the size, shape and number of slots, the shape of surface 111, the configuration of engraved lines 114, and the manner in which the lines are produced. With the use of these design parameters for nozzle 41 many advantages can be observed. Since the induction cleaning chemistry can be delivered to the carbon sites throughout the induction system the carbon removal from all such sites can be accomplished. Additionally, no induction or air filter boots will need to be removed. If a MAF sensor is used it will still be intact and be able to send air weight data to the ECU. Since the engine and sensors are all intact the engine will run normally during induction cleaning without setting any Diagnostic Trouble Codes (DTC). This will allow the throttle and RPM to be changed during induction cleaning. With the throttle opened or during snap throttle events the air column flowing into the engine has greater energy which allows the selected induction cleaning chemistry to have more force when impacting the carbon sites, thus having a greater cleaning impact. Another advantage is the nozzle will work in gasoline based engines or diesel based engines as both style engines have an induction system with an opening or port into the intake system. Yet another advantage is that the throttle plate and throttle body on gasoline based engines are not cleaned. If the throttle body around the throttle plate is cleaned the air flow rate around the plate is changed as well. If one is using a pressurized cleaning system and injecting the cleaner across the throttle plate, it will be necessary to have enhanced scan tools that can reset DTC's and relearn idle control functions. (Some manufactures such as Nissan will need the idle air rate relearned when you have finished cleaning the induction system.) If the throttle plate and bore need to be cleaned this can easily be accomplished by using an aerosol can with throttle body cleaner. This allows the service person to decide whether or not to clean the throttle body.

In FIG. 19 the preferred electronic control circuit for the Dual Solenoid Induction Cleaner is shown. The microprocessor 96 controls the Dual Solenoid Induction Cleaner. The engine run sensor 45 sends vibration signal to microprocessor 96 where this signal is processed for enabling criteria. The air pressure sensor switch 11 sends signal to microprocessor 96 where this signal is also processed for enabling criteria. Control switches 97, 98, and 99 are used by the service person to send signals to microprocessor 96 that control the Dual Solenoid Induction Cleaner. Drivers 100 and 101 are used to turn solenoids 36 and 37 on and off. Drivers 102 and 103 are used to control starter solenoid circuit. Driver 104 is used to control audio alert 105 to alert service person to different conditions of the Dual Solenoid Induction Cleaner. Lamp circuits 107 are controlled by microprocessor 96 to alert service person to different conditions of the Dual Solenoid Induction Cleaner.

In order for microprocessor 96 to control the hardware a program for the operation of the Dual Solenoid Induction Cleaner was created. The preferred embodiment is shown in FIG. 20. The program takes into account the various operating conditions of the device, including the run profiles stored in microprocessor 96, as well as the service person interaction with the device. This program not only sets up the operation of the device but also accounts for the safety of the system, the vehicle, and the service person. This is accomplished with three safety systems; the air pressure, the engine running sensor and the battery voltage. These three safeties will only allow the chemistry to be delivered under the correct conditions. This will protect the service person from chemical discharge which, if it occurs at the wrong time, could get injected on the service person or the vehicles paint. It will prevent the system from discharging chemistry into the induction with the engine off which could hydrolock the engine causing severe damage to it. Additionally it will protect the vehicle and the vehicle's microprocessors from low battery voltages. Which can cause DTC's to be set in the vehicles computer system or damage to the electronics from low battery voltage. The program also accounts for the visual and audio alerts that will be conveyed to the service person.

It is important to understand that anyone skilled in the art could alter the above described instrumentation and controls in many ways including, but not limited to, using basic electronics instead of a microprocessor to accomplish these same results. The Dual Solenoid Induction Cleaner could be designed to function with just specific chemistries supplied by a particular manufacturer/distributor. In such a situation a microprocessor with different run profiles for the various available chemistries from competing entities would not be necessary. Control of, for instance, the solenoids could be controlled by basic electronics.

Whereas the drawing and accompanying description have shown and described the preferred embodiments of the present invention, it should be apparent to those skilled in the art that various changes may be made in the forms and uses of the inventions without affecting the scope thereof.

We claim:

1. A method of removing carbon build up from the internal combustion engine of a vehicle; the engine including an induction system, combustion chambers, and exhaust valves; the vehicle also including a starting system; the method including the use of first and second different chemical compositions of matter (herein, respectively, “first chemistry” and “second chemistry”) each capable of removing at least some carbon in at least a portion of the engine, and means for delivering the first and second chemistries to the induction system in stages; the method including:
running the engine;
applying the first chemistry to the induction system for a first period of time (herein the “first stage”);
applying the second chemistry to the induction system for a second period of time (herein the “second stage”; the first and second stages constituting a “cycle”); and
repeating the cycle at least once.

2. The method as set forth in claim 1, further including the step of predetermining one of the first and second periods of time.

3. The method as set forth in claim 2, wherein the step of predetermining one of the first and second time periods is based at least in part on the formulation of the chemistry used during such time period and the flow rate of such chemistry into the induction system.

4. The method as set forth in claim 1, further including the step of predetermining both the first and second time periods.

5. The method as set forth in claim 4, wherein the step of predetermining both the first and second time periods is based at least in part on the formulation of the chemistry used during each of the first and second time periods and the respective flow rates of the first and second chemistries into the induction system.

6. The method as set forth in claim 1, further including repeating the cycle for either a predetermined period of time or a predetermined number of cycles.

7. The method as set forth in claim 6, wherein both the predetermined period of time for repeating the cycle and the predetermined number of cycles is based at least in part on the formulation of the chemistry used during each of the first and second periods of time and the flow rates of the first and second chemistries into the induction system during the first and second periods of time.

8. The method as set forth in claim 1, wherein the means for delivering the first and second chemistries to the induction system includes means for at least partially changing both the first and second chemistries from a liquid to liquid droplets, and wherein the steps of applying the first and second chemistries includes applying liquid droplets of the first chemistry during the first stage and liquid droplets of the second chemistry during the second stage to the induction system.

9. The method as set forth in claim 8, wherein the means for at least partially changing both the first and second chemistries from a liquid to liquid droplets includes use of a pressure differential, and wherein the steps of applying liquid droplets includes delivering the first and second chemistries to the induction system with the use of the pressure differential.

10. The method as set forth in claim 8, wherein the means for at least partially changing both the first and second chemistries from a liquid to liquid droplets includes a means for changing the liquid into an aerosol, and wherein the step of applying liquid droplets includes the step of converting the liquid into an aerosol as it enters the induction system.

11. The method as set forth in claim 8, wherein the induction system includes an intake port, wherein at least partially changing both the first and second chemistries from a liquid to liquid droplets includes use of a nozzle and a pressure differential, and wherein the steps of applying liquid droplets includes inserting the nozzle through the intake port and into the induction system and delivering both the first and second chemistries by use of the nozzle and the pressure differential.

12. The method as set forth in claim 11, wherein the means for at least partially changing both the first and second chemistries from a liquid to liquid droplets includes a means for changing the liquid into an aerosol, and wherein the step of applying liquid droplets includes the step of converting the liquid into an aerosol as it enters the induction system.

13. The method as set forth in claim 1, wherein the steps of applying during both the first and second stages includes using a pressure differential to move the first and second chemistries into the induction system.

14. The method as set forth in claim 13, wherein the use of a pressure differential is the use of the vacuum inherent in the induction system when the engine is running.

15. The method as set forth in claim 13, wherein the means for delivering the first and second chemistries to the induction system includes a source of pressurized gas, and wherein the steps of applying the first and second chemistries with the use of a pressure deferential includes the use of the source of pressurized gas to move the first and second chemistries into the induction system.

16. The method as set forth in claim 1, further including a control system to start and stop the flow of the first and second chemistries to the induction system, and wherein the steps of applying the first and second chemistries includes using the control system to start and stop the flow of each of the first and second chemistries into the induction system.

17. The method as set forth in claim 16, wherein the control system includes electronics; the electronics including means for storing the profile of the first chemistry (herein the “first profile”) and the profile of the second chemistry (herein the “second profile”), and a routine for determining the time period for the first stage to run based in the first profile (the “first run time”) and the time period for the second stage to run based on the second profile (the “second run time”); the method further including:
selecting the first profile;
selecting the second profile;
automatically selecting the first and second run times;
automatically running the two stages (the running of the first and second stages constituting a “cycle”);
repeating the cycle at least once.

18. The method as set forth in claim 17, wherein the electronics also includes a routine for determining the number of times the cycle should be repeated, and further including the step of automatically repeating the cycle the determined number of times.

19. The method as set forth in claim 17, wherein the routine for determining the run time for at least one of the first and second profiles can be varied as the cycle is repeated, further including the step of varying at least one of the run times in a cycle following the first cycle.

20. The method as set forth in claim 17, wherein the electronics also includes a routine for determining the time between when the flow of the first chemistry stops and the flow of the second chemistry begins (the “pause time”), the method further including:
automatically selecting the first run time, the pause time and the second run time; and
automatically running the stages associated with the three time periods.

21. The method as set forth in claim 1, wherein the second stage directly follows the first stage.

22. The method as set forth in claim 1, wherein the second stage overlaps the first stage.

23. The method as set forth in claim 1, further including the step of including a time period between the stages (herein the “pause stage”) wherein no chemistry is being applied to the induction system.

24. The method as set forth in claim 23, further including the step of including a time period between the end of the first stage and the beginning of the second stage of the next cycle (herein the “first pause stage”) wherein no chemistry is being applied to the induction system, the first, pause, and second stages constituting the cycle.

25. The method as set forth in claim 24, further including repeating the cycle for either a predetermined period of time or a predetermined number of cycles.

26. The method as set forth in claim 25, wherein the first pause stage is sufficiently long to permit the first chemistry to at least partially soak the carbon buildup in the induction system.

27. The method as set forth in claim 26, wherein the application of the second chemistry during the second stage can wash out of the induction system at least some of the carbon that has been at least partially soaked by the first chemistry during the first pause stage.

28. The method as set forth in claim 23, further including the step of including a time period between the end of the second stage and the beginning of the first stage of the next cycle (herein the “second pause stage”) wherein no chemistry is being applied to the induction system, the first, second, and second pause stages constituting the cycle.

29. The method as set forth in claim 28, further including repeating the cycle for either a predetermined period of time or a predetermined number of cycles.

30. The method as set forth in claim 28, wherein the second pause stage is sufficiently long to permit the second chemistry to at least partially soak the carbon buildup in the induction system.

31. The method as set forth in claim 30, wherein the application of the first chemistry after the conclusion of the second pause stage can wash out of the induction system at least some of the carbon that has been at least partially soaked by the second chemistry during the second pause stage.

32. The method as set forth in claim 23, further including the step of including a time period between the end of the first stage and the beginning of the second stage (herein the “first pause stage”) and including a time period between the end of the second stage and the beginning of the first stage (herein the “second pause stage”) wherein no chemistry is being applied to the induction system, the first stage, first pause stage, second stage, and second pause stage constituting the cycle.

33. The method as set forth in claim 23, wherein the vehicle includes an exhaust system including a catalytic converter and/or a turbocharger, wherein the pause stage is sufficiently long to thereby reduce the risk of damage to the vehicle's catalytic converter and/or a turbocharger.

34. The method as set forth in claim 33, further including the step of including a time period between the end of the second stage and the beginning of the first stage of the next cycle (herein the “second pause stage”) wherein no chemistry is being applied to the induction system to thereby reduce the risk of damage to the vehicle's catalytic converter; the first, second, pause and second pause stages constituting the cycle.

35. The method as set forth in claim 1, further including a third chemical composition of matter different from both the first chemistry and the second chemistry (herein the “third chemistry”), the means for delivering including means for delivering the third chemistry to the induction system; further including:
applying the third chemistry to the induction system for a third period of time (hereinafter the “third stage”), whereby the first, second and third stages constitute a cycle; and
repeating the three stage cycle at least once.

36. The method as set forth in claim 35, wherein the second stage directly follows the first stage, and the third stage directly follows the second stage.

37. The method as set forth in claim 35, wherein at least two of the first, second and third stages overlap each other.

38. The method as set forth in claim 37, wherein the first and second stages overlap and the second and third stages overlap.

39. The method as set forth in claim 37, wherein the first and second stages overlap, the second and third stages overlap, and the third and first stages overlap.

40. The method as set forth in claim 35, further including:
the step of including a time period between the first and second stages (herein the “first pause stage”) wherein neither the first nor the second chemistry is being applied to the induction system;
the step of including a period of time between the second and third stages (herein the “second pause stage”) wherein neither the second nor the third chemistry is being applied to the induction system, the first stage, the first pause stage, the second stage, the second pause stage, and the third stage constituting the cycle; and
repeating the cycle at least once.

41. The method as set forth in claim 40, further including the step of including a time period between the end of third stage and the beginning of the first stage of the next cycle (herein the “third pause stage” where no chemistry is being applied to the induction system, the first stage, the first pause stage, the second stage, the second pause stage, the third stage, and the third pause stage constituting the cycle.

42. A method of removing carbon build up from the internal combustion engine of a vehicle;
the engine including an induction system, combustion chambers, and exhaust valves; the vehicle also including a starting system; the method including the use of a chemical composition of matter (herein “chemistry”) capable of removing at least some carbon in at least a portion of the engine and means for delivering the chemistry to the induction system in stages; the method including:
running the engine;
applying the chemistry to the induction system for a first period of time (herein the “single chemistry stage”);
providing a second period of time wherein the chemistry is not being applied to the induction system (herein the “single chemistry pause stage”);
repeating the single chemistry first stage, wherein the single chemistry/single chemistry pause stage sequence constitutes a “single chemistry cycle”; and
repeating the single chemistry cycle at least once.

43. The method as set forth in claim 42, further including the step of predetermining both the first and second time periods.

44. The method as set forth in claim 43, wherein the step of predetermining the first time period is based at least in part on the formulation of the chemistry used during the single chemistry stage and the flow rate of such chemistry into the induction system.

45. The method as set forth in claim 42, wherein the means for delivering the chemistry to the induction system includes means for at least partially changing the chemistry from a liquid to liquid droplets, and wherein the step of applying the chemistry includes applying liquid droplets of the chemistry during the single chemistry stage to the induction system.

46. The method as set forth in claim 45, wherein the means for at least partially changing the chemistry from a liquid to liquid droplets includes use of a pressure differential, and wherein the step of applying liquid droplets includes delivering the chemistry to the induction system with the use of the pressure differential.

47. The method as set forth in claim 45, wherein the induction system includes an intake port into the induction system, wherein at least partially changing the chemistry from a liquid to liquid droplets includes use of a nozzle and a pressure differential, and wherein the steps of applying liquid droplets includes inserting the nozzle through the intake port and into the induction system and delivering the chemistry by use of the nozzle and the pressure differential.

48. The method as set forth in claim 46, wherein the use of a pressure differential is the use of the vacuum inherent in the induction system when the engine is running.

49. The method as set forth in claim 46, wherein the means for delivering the chemistry to the induction system includes a source of pressurized gas, and wherein the step of applying the chemistry with the use of a pressure deferential includes the use of the source of pressurized gas to move the chemistry into the induction system.

50. The method as set forth in claim 42, further including a control system to start and stop the flow of the chemistry to the induction system, and wherein the step of applying the chemistry includes using the control system to start and stop the flow of the chemistry into the induction system.

51. The method as set forth in claim 50, wherein the control system includes electronics; the electronics including means for storing the profile of the chemistry (herein the “profile”) and a routine for determining the time period for the single chemistry stage to run based in the profile (the “single chemistry run time”), and the time period when the chemistry is not being applied to the induction system (the “single chemistry pause time”); the method further including:
selecting the profile;
automatically selecting the single chemistry run time and the single chemisstry pause time;
automatically running the two times (the running of the single chemistry run time and the single chemistry pause time constituting a “cycle”);
repeating the cycle at least once.

52. The method as set forth in claim 51, further including repeating the cycle for either a predetermined period of time or a predetermined number of cycles.

53. The method as set forth in claim 42, wherein the single chemistry pause stage is sufficiently long to permit the chemistry to at least partially soak the carbon buildup in the induction system.

54. The method as set forth in claim 53, wherein the application of the chemistry during the second cycle can wash out of the induction system at least some of the carbon that has been at least partially soaked by the chemistry during the preceding single chemistry pause stage.

55. A method of removing carbon build up from the internal combustion engine of a vehicle; the engine including an induction system, combustion chambers, and exhaust valves; the vehicle also including a starting system; the method including the use of a chemical composition of matter (herein “chemistry”) capable of removing at least some carbon in at least a portion of the engine and means for delivering the chemistry to the induction system in stages; the method including:
cranking the engine;
applying the chemistry to at least the induction system while the engine is cranking (herein, the “cranking phase”);
stop cranking the engine; and
providing a period of time (the “presoak phase”) after the cranking has ceased and before the engine is started and running for the chemistry to soak at least some of the carbon in, at least, portions of the induction system.

56. The method as set forth in claim 55, further including the steps of;
starting and running the engine; and
applying chemistry that can remove at least some carbon to the induction system, so as to remove at least some of the presoaked carbon from at least the induction system of the internal combustion engine.

57. The method as set forth in claim 55, wherein the means for delivering chemistry to, at least, the induction system includes an electronic circuit for sending a signal to engage the starter and crank the engine while chemistry is being delivered to the induction system during the cranking phase, where the step of cranking the engine includes controlling the cranking with the electronic circuit.

58. The method as set forth in claim 57, wherein the electronic circuit includes a circuit for timing the presoak phase and an alert triggered at the end of the presoak phase, further including activating the alert at the end of the presoak phase.

59. Apparatus for delivering droplets of at least one selected chemical composition of matter (herein “chemistry”) through an intake port and into the interior of the induction system of an internal combustion engine; the chemistry capable of removing carbon from the induction system; the apparatus including a nozzle for delivering chemistry into the interior of the induction system; the nozzle including a hollow tube having first and second ends, a size small enough to fit through the intake port and long enough so that the first end will project into the induction system when the tube is inserted in the port; the tube having a first opening associated with the first end and a second opening associated with the second end; the nozzle further including means for positioning the tube in the induction system such that the first end is positioned inside the induction system and in the column of air moving through the induction system when the engine is running.

60. The apparatus as set forth in claim 59, wherein the first opening takes the form of the exposed first end of the hollow tube.

61. The apparatus as set forth in claim 59, wherein the hollow tube is plugged at the first end and the first opening takes the form of at least one opening in the side of the hollow tube in the area adjacent to the plugged opening.

62. The apparatus as set forth in claim 61, wherein the at least one opening is configured so that, when the engine is running and air flowing through the induction system, at least some of the chemistry is delivered into the induction system in the form of droplets which are configured so that at least some of them will be carried by the air flow throughout the induction system.

63. The apparatus as set forth in claim 62, wherein the at least one opening is configured so that, for the selected chemistry, the target range for the droplets is larger than those which will normally turn to vapor when the engine is running and smaller than droplets which are so large that fall out of the air flow and puddle in the induction system.

64. The apparatus as set forth in claim 61, wherein at least the portion of the tube designed to project through the port and into the induction system is substantially straight and has a longitudinal axis, and wherein the at least one opening is configured so that the droplets of chemistry exiting from such opening are directed outwardly from and generally orthogonal to the longitudinal axis.

65. The apparatus as set forth in claim 61, wherein the at least one opening takes the form of a plurality of openings in the side of the hollow tube.

66. The apparatus as set forth in claim 65, wherein at least the portion of the tube designed to project through the port and into the induction system is substantially straight and has a longitudinal axis, and wherein the plurality of openings are in a line along the side of the tube, approximately parallel to the longitudinal axis.

67. The apparatus as set forth in claim 65, wherein at least the portion of the tube designed to project through the port and into the induction system is substantially straight and has a longitudinal axis, and wherein the plurality of openings are approximately in a plane perpendicular to the longitudinal axis of the tube.

68. The apparatus as set forth in claim 61, wherein the tube has a longitudinal axis, and wherein the plug at the first end is adjustable along the longitudinal axis adjustably control the flow of chemistry through the at least one opening.

69. The apparatus as set forth in claim 61, wherein the tube has a longitudinal axis and an internal seat proximate to the first opening, and wherein the plug at the first end is adjustable along the longitudinal axis and includes a surface to, in conjunction with the internal seat, adjustably control the flow of chemistry through the at least one opening.

70. The apparatus as set forth in claim 69, wherein the at least one opening takes the form of a plurality of openings lying in a plane substantially perpendicular to the longitudinal axis, and wherein the plug surface includes means to direct the chemistry to each of the plurality of openings.

71. The apparatus as set forth in claim 70, wherein the means to direct chemistry is a surface feature formed in the plug surface.

72. The apparatus as set forth in claim 71, wherein the surface feature is a line, channel or groove formed in the plug surface.

73. The apparatus as set forth in claim 72, wherein the configuration of the line/channel/groove (herein “line”) is selected from the group including: (1) a single line across the surface; (2) two lines across the surface substantially perpendicular to each other; (3) two lines across the surface substantially parallel to each other; and (4) two sets of lines substantially parallel to each other, which sets are substantially perpendicular to each other.

74. The apparatus as set forth in claim 73, wherein the surface includes a cone shaped portion having a perimeter area, and wherein the lines extend across the cone shaped surface from substantially one side of the perimeter area to the opposite side of the perimeter area.

75. The apparatus as set forth in claim 73, wherein the surface includes a cone shaped portion having a perimeter area and an apex area, and wherein (with regard to each of the two sets of lines) one line of each set extends from one side of the perimeter area across the apex area but not to the other side of the perimeter area and the other line extends from the other side of the perimeter area across the apex area but not to the one side of the perimeter area.

76. The apparatus as set forth in claim 75, wherein the four lines cross each other in the apex area, but none extend to both sides of the perimeter area.

77. The apparatus as set forth in claim 59, wherein the means for positioning the first end of the tube in the intake port takes the form of a means to seal the intake port against the tube side.

78. The apparatus as set forth in claim 77, wherein the means to seal the intake port includes a tapered surface which is designed to seal the intake port and an opening to slideably receive a portion of the tube to permit adjustment of the position of the first end in the induction system.

79. The apparatus as set forth in claim 59, further including at least one containment reservoir for the storage of the chemistry and means for connecting the nozzle to the reservoir.

80. The apparatus as set forth in claim 79, wherein the means for connecting includes means to control the flow of chemistry from the reservoir to the nozzle.

81. The apparatus as set forth in claim 80, wherein the flow control means includes a valve which can be opened and closed to connect and disconnect the reservoir from the nozzle.

82. The apparatus as set forth in claim 81, wherein the flow control means includes means for controlling the length of time the valve is open and the length of time the valve is closed.

83. The apparatus as set forth in claim 82, wherein the means for controlling the length of time the valve is open and the length of time the valve is closed includes electronic circuit means including a timing means.

84. The apparatus as set forth in claim 83, wherein the electronic circuit means also includes means to control the number of cycles in which the valve is opened and closed.

85. The apparatus as set forth in claim 84, wherein the electronic circuit means includes a microprocessor including a routine for controlling the length of time the valve is on and the length of time the valve is off and the number of cycles.

86. The apparatus as set forth in claim 79, further including a source of pressurized gas connected to the reservoir to move the chemistry from the reservoir to the nozzle, whereby (in operation) the chemistry is injected into the induction system under pressure.

87. The apparatus as set forth in claim 79, wherein the means for connecting the nozzle to the reservoir includes an air bleed.

88. The apparatus as set forth in claim 79, further including a second containment reservoir for the storage of a second chemistry also capable of removing carbon from the induction system, and wherein the means for connecting the nozzle to the reservoir includes means for connecting the second reservoir to the nozzle, whereby two different chemistries can be delivered by the nozzle to the induction system.

89. The apparatus as set forth in claim 88, further including means to control both the flow of the chemistry form the reservoir to the nozzle and the flow of the second chemistry from the second reservoir to the nozzle; the flow control means including a valve which can be opened and closed to connect and disconnect the reservoir from the nozzle, and a second valve which can be opened and closed to connect and disconnect the second reservoir from the nozzle; the flow control means further including means for controlling the length of time the valve is open, the length of time the valve is closed, the length of time the second valve is open and the length of time the second valve is closed; the flow control means also including means for determining the sequence of opening and closing the valve and the second valve and the number of cycles in which both the valve and the second valve are opened and closed.

90. The apparatus as set forth in claim 89, wherein the flow control means includes electric circuit means including timing electronics.

91. The apparatus as set forth in claim 90, wherein the electronic circuit means includes a microprocessor including a routine for controlling the length of time each of the valve and second valve is on and then off, the on/off sequence of the valve relative to the second valve, and the number of cycles the on/off sequence is repeated.

92. The apparatus as set forth in claim 91, wherein the routine also includes the time periods when both valves are both off.

93. The use of the apparatus of claim 59 to inject droplets of chemistry directly into the induction system of a running engine to:
maximize the formation of droplets that will stay suspended in the air column as it moves through the induction system; and/or
reduce the formation of droplets which fall out of the air column and puddle; and/or
minimize the formation of droplets which will tend to vaporize when the engine is running.

94. Apparatus for delivering droplets of at least one chemical composition of matter (herein “chemistry”) into the interior of the induction system of an internal combustion engine, the chemistry capable of removing carbon from the induction system; the apparatus including a nozzle for delivering chemistry into the interior of the induction system, at least one containment reservoir for the storage of the chemistry, means for connecting the nozzle to the reservoir, and means to control the flow of the chemistry from the reservoir to the nozzle; the flow control means including a valve which can be opened and closed to connect and disconnect the reservoir from the nozzle; the flow control means further including means for controlling the length of time the valve is open and the length of time the valve is closed; the flow control means also including means for determining the number of cycles in which both the valve is opened and closed.

95. The apparatus as set forth in claim 94, wherein the means of controlling the length of time the valve is open and the length of time the valve is closed, and for determining the number of cycles includes electronic circuit means.

96. The apparatus as set forth in claim 95, wherein the electronic circuit means includes a microprocessor including a routine controlling the length of time the valve is on and the length of time the valve is off and the number of cycles.

97. The apparatus as set forth in claim 94, further including a second containment reservoir for the storage of a second chemistry also capable of removing carbon from the induction system;
wherein the means for connecting the nozzle to the reservoir includes means for connecting the second reservoir to the nozzle, whereby two different chemistries can be delivered by the nozzle to the induction system; wherein the means to control both the flow of the chemistry from the reservoir to the nozzle includes a second valve which can be opened and closed to connect and disconnect the second reservoir from the nozzle; the flow control means further including means for controlling the length of time the second valve is opened and the length of time the second valve is closed; the flow control means also including means for determining the sequence of opening and closing the valve and the second valve and the number of cycles in which both the valve and the second valve are opened and closed.

98. The apparatus as set forth in claim 97, wherein the means of controlling the length of time the valves are open and the length of time the valves are closed, and for determining the number of cycles includes electronic circuit means.

99. The apparatus as set forth in claim 98, wherein the electronic circuit means includes a microprocessor including a routine controlling the length of time the valve is on and the length of time the valve is off, the length of time the second valve is on and the length of time the second valve if off, and the number of cycles (each cycle including the time the valve if on, the valve is off, the second valve is on, and the second valve is off).

100. A method of delivering droplets of at least one chemical composition of matter (herein “chemistry”) from a source into the induction system of an internal combustion engine with the aid of a nozzle and means for connecting the nozzle to the source; the chemistry capable of removing carbon from the induction system; the induction system including an intake port which can be opened and closed; the nozzle including a hollow tube having first and second ends, a size small enough to fit through the intake port and long enough so that the first end will project into the induction system when the tube is inserted in the port; the tube having opening means associated with the first end for dispersing the droplets of chemistry into the induction system, the second end connected to the means for connecting the source to the nozzle; the method including:
running the engine;
opening the intake port;
inserting the first end of the nozzle through the intake port and into the induction system and the air column moving there through;
delivering the chemistry from the source to the nozzle; and
controlling the formation of chemistry droplets from the opening means to produce droplets that can stay suspended in the air column as it moves through the induction system.

101. The method as set forth in claim 100, wherein the means for connecting the nozzle to the source includes a source of pressure and means for regulating the pressure delivered to the nozzle, and wherein the step of controlling the formation of droplets that stay suspended in the air column includes the step of regulating the pressure of the chemistry delivered to the first opening.

102. The method as set forth in claim 100, wherein the tube has a longitudinal axis and a plug at the first end which is adjustable along the longitudinal axis; the plug including a means to adjustably control the flow of chemistry through the opening means; and wherein the step controlling the formation of chemistry droplets includes the step of adjusting the means to control the flow through the opening means.

103. The method as set forth in claim 100, wherein the tube has a longitudinal axis and an internal seat proximate to the first end; wherein the tube also includes a plug at the first end which is adjustable along the longitudinal axis and includes a surface area to, in conjunction with the seat, adjustably control the flow of chemistry through the opening means; and wherein the step controlling the formation of chemistry droplets includes the step of adjusting the surface on the plug relative to the seat.

104. The method as set forth in claim 103, wherein the plug also includes a surface area having at least one feature which affects the formation of droplets before they exit from the opening means, and wherein the step of affecting the formation of chemistry droplets includes directing the chemistry onto the at least one surface feature.

105. The method as set forth in claim 104, wherein the at least one surface feature is selected from the group including lines, channels and grooves.

106. The method as set forth in claim 100, wherein the step of controlling the formation of the chemistry droplets includes the step of selecting a particular chemistry.

107. The method as set forth in claim 100, wherein the step of controlling includes the step of forming droplets within a target range larger than droplets that will turn into vapor and smaller than droplets which are so large that they will tend to fall out of the air flow.

108. The method as set forth in claim 100, wherein the configuration of the chemistry droplets exiting from the first opening means is controlled at least in part by factors included in the group including formulation of the chemistry, the pressure at which the chemistry is delivered to the first opening means, and the configuration of the first opening means.

109. A method of delivering droplets of at least one chemical composition of matter (herein “chemistry”) from a source into the induction system of an internal combustion engine with the aid of a nozzle and means for connecting the nozzle to the source; the chemistry capable of removing carbon from the induction system; the induction system including an intake port which can be opened and closed; the method including:
running the engine;
opening the intake port;
inserting the first end of the nozzle through the intake port and into the induction system and the air column moving there through;
delivering the chemistry from the source to the nozzle; and
controlling the formation of chemistry droplets from the opening means to produce droplets that can stay suspended in the air column as it moves through the induction system.

110. A method of determining the running state (i.e., not running, and running) of an engine with apparatus external to the engine for use in affecting an engine testing and/or maintenance procedure; the engine including a starting system; the apparatus including a sensor, electronics for processing signals from the sensor and for controlling an engine testing and/or maintenance procedure based in part on the signals from the sensor, means for attaching the sensor to the engine, and means for connecting the sensor to the electronics; the method including:
attaching the sensor to the vehicle;
sensing the absence of engine vibration (“engine off condition”); and
sensing the vibration from the engine when the engine is running (“engine running condition”).

111. The method as set forth in claim 110, further including:
sending a signal indicative of engine running state to the electronics; and
controlling the engine testing and/or maintenance procedure with the electronics based on the engine running signal from the sensor.

112. The method as set forth in claim 111, wherein the sensor is selected from the group including an accelerometer, a microphone, tailpipe pressure transducer, crankcase pressure transducer, and induction pressure transducer (herein “accelerometer”), and wherein the method includes using the accelerometer to sense the engine off condition, and the engine running condition.

113. A method of determining the running state (i.e., not running, running, or cranking) of an engine with apparatus external to the engine for use in affecting an engine testing and/or maintenance procedure; the engine including means for cranking the engine and a battery; the apparatus including a sensor, electronics for processing signals from the sensor and for controlling an engine testing and/or maintenance procedure based in part on the signals from the sensor, means for attaching the sensor to the engine, and means for connecting the sensor to the electronics; the method including:
attaching the sensor to the engine;
sensing the absence of engine vibrations (“engine off condition”);
sending a signal from the sensor to the electronics indicating the absence of engine vibrations;
cranking the engine by supplying voltage from the battery to the means for cranking;
sensing the vibrations from the engine when the engine when the engine is cranking (“engine cranking condition”);
sending a signal from the sensor indicative of engine cranking to the electronics; and
controlling at least a portion of the engine testing and/or maintenance procedure with the electronics based on the signals received from the sensor.

114. The method as set forth in claim 113, further including:
running the engine;
sensing the vibrations from the engine when the engine is running (“engine running condition”);
sending a signal from the sensor indicative of engine running to the electronics; and
controlling at least a portion of the engine testing and/or maintenance procedure with the electronics based on the engine running signal from the sensor.

115. The method as set forth in claim 114, wherein the sensor is selected from the group including an accelerometer, a microphone, tailpipe pressure transducer, crankcase pressure transducer, and induction pressure transducer (herein “accelerometer”), and wherein the method includes using the accelerometer to sense the engine off condition, the engine cranking condition and the engine running condition.

116. The method as set forth in claim 113, wherein the engine includes an induction system; wherein the apparatus further includes a source of induction cleaning chemistry and means for delivering induction cleaning chemistry from the source to the induction system; wherein the means for delivering the induction cleaning chemistry includes means for starting and then stopping the flow of induction cleaning chemistry to the induction system; wherein the electronics includes an enabling criteria routine for controlling the means for starting and then stopping the flow of induction cleaning chemistry to the induction system; the method including:
starting the flow of induction cleaning chemistry to the induction system when the sensor senses the start of the engine cranking condition; and
stopping the flow of induction cleaning chemistry when the sensor senses that the engine is no longer cranking.

117. The method as set forth in claim 116, wherein the enabling criteria routine includes a timing routine to prevent the restart of induction cleaning chemistry to the induction system for a predetermined period of time (the “pause period run time”) after the engine has ceased cranking to permit the induction cleaning chemistry to soak carbon in the induction system, further including stopping the flow of induction cleaning chemistry during the pause period run time.

118. The method as set forth in claim 117, wherein the enabling criteria routine includes a routine for running the engine and starting and then stopping the flow of induction cleaning chemistry to the induction system after the pause period run time has ended, further including:
starting and running the engine at the end of the pause period run time;
sensing the engine running condition with the sensor;
sending a signal from the sensor to the electronics indicative of engine running; and
starting the flow of induction cleaning chemistry when the engine starts running.

119. The method as set forth in claim 113, wherein the engine includes an induction system; wherein the apparatus further includes a source of induction cleaning chemistry and means for delivering induction cleaning chemistry from the source to the induction system; wherein the means for delivering the induction cleaning chemistry includes means for starting and then stopping the flow of induction cleaning chemistry to the induction system; wherein the electronics includes an enabling criteria routine for controlling the means for starting and then stopping the flow of induction cleaning chemistry to the induction system; further including:
sensing the engine running condition with the sensor;
sending a signal from the sensor to the electronics indicative of engine running; and
starting the flow of induction cleaning chemistry when the engine starts running.

120. The method as set forth in claim 114, wherein the apparatus includes at least one alert and electronics for activating the alert when the engine state is in the condition selected from the group including engine off, engine cranking and engine running, and further including activating the alert when the sensor indicates that the engine is in the selected condition.

121. The method as set forth in claim 120, wherein the at least one alert includes both an audio and a visual alert, and further including activating both alerts when the engine is in the selected condition.

122. The method as set forth in claim 116, wherein the apparatus includes means for pressurizing the source of induction cleaning chemistry, and further including pressurizing the induction cleaning chemistry whereby the flow to the induction system is under pressure.

123. The method as set forth in claim 122, wherein the apparatus includes means for sensing the pressure on the induction cleaning chemistry, wherein the enabling criteria routine includes a predetermined minimum value for the pressure, and further including starting the flow of induction cleaning chemistry only if the pressure is at or above the predetermined minimum value.

124. The method as set forth in claim 123, further including stopping the flow of induction cleaning chemistry if the pressure falls below the predetermined value.

125. The method as set forth in claim 119, further including:
sensing when the engine running condition stops; and
stopping the flow of induction cleaning chemistry when the engine is not running.
